(19) United States
(12) Patent Application Publication
(10) Pub. No.: US 2025/0012723 A1
(43) Pub. Date: Jan. 9, 2025

(54) Detecting Multiple Fluorophores Using Swept, Confocally-Aligned Planar Excitation (SCAPE) Microscopy

(71) Applicant: The Trustees of Columbia University in the City of New York, New York, NY (US)

(72) Inventor: Elizabeth M.C. HILLMAN, New York, NY (US)

(73) Assignee: The Trustees of Columbia University in the City of New York, New York, NY (US)

(21) Appl. No.: 18/888,927

(22) Filed: Sep. 18, 2024

Related U.S. Application Data
(63) Continuation of application No. PCT/US2023/016127, filed on Mar. 23, 2023.
(60) Provisional application No. 63/323,787, filed on Mar. 25, 2022.
(60) Provisional application No. 63/323,785, filed on Mar. 25, 2022.
(60) Provisional application No. 63/322,751, filed on Mar. 23, 2022.

(51) Int. Cl. G01N 21/64

(52) U.S. Cl. CPC G01N 21/6428; G01N 21/6458; G01N 2021/6439; G01N 2021/6463

(57) ABSTRACT

Multiple fluorophores within a sample can be imaged by merging a plurality of beams from different wavelength light sources of excitation light into a single path, directing the excitation light into the sample, and detecting light emitted by the fluorophores within the sample on two different arrays of pixels (e.g., two regions within a single camera sensor chip). The light sources are activated during respective timeslots, and captured image data is processed. For at least one of the timeslots, the processing of the image data comprises using the image data captured using the first array of pixels to detect a presence of a given fluorophore, and using the image data captured using the second array of pixels to detect a presence of a different fluorophore. This arrangement enables a system that includes only N light sources to image more than N fluorophores.

### CROSS REFERENCE TO RELATED APPLICATIONS

This Application is a continuation of International Application PCT/US2023/016127 (filed Mar. 23, 2023), which claims the benefit of U.S. Provisional Applications 63/322,751 (filed Mar. 23, 2022), 63/323,785 (filed Mar. 25, 2022), and 63/323,787 (filed Mar. 25, 2022), each of which is incorporated herein by reference in its entirety.

### STATEMENT REGARDING FEDERALLY-SPONSORED RESEARCH

This invention was made with government support under grants NS094296, NS104649, NS108213, and CA236554 awarded by the National Institutes of Health and under grants 0801530, 0954796, and 1644869 awarded by the National Science Foundation. The government has certain rights in the invention.

### BACKGROUND

U.S. Pat. Nos. 10,061,111, 10,831,014, 10,835,111, 10,852,520, and 10,908,088, each of which is incorporated herein by reference, describe a variety of approaches for implementing Swept, Confocally-Aligned Planar Excitation (SCAPE) microscopy.

### SUMMARY OF THE INVENTION

One aspect of this application is directed to a first imaging apparatus that comprises an optical image splitter, an optical beam combiner, a set of optical components, and at least one processor. The optical image splitter is configured to route a first set of wavelengths of light towards a first array of first pixels of at least one camera and to route a second set of wavelengths of light towards a second array of second pixels of the at least one camera. The optical beam combiner is configured to route a plurality of beams of excitation light that emanate from a respective plurality of light sources onto a single common excitation path, and each of the plurality of light sources outputs a respective beam of excitation light that has a respective center wavelength. The set of optical components is configured to (a) route the plurality of beams of excitation light from the single common excitation path into a sample and (b) when a fluorophore within the sample emits light in response to incoming excitation light, route at least a portion of the emission light that exits the sample into the image splitter. And the at least one processor is programmed to activate each of the plurality of light sources during a respective timeslot, and process image data captured using the first array of first pixels and/or image data captured using the second array of second pixels during each of the timeslots. For at least one of the timeslots, the processing of the image data comprises using the image data captured using the first array of first pixels to detect a presence of a given fluorophore, and using the image data captured using the second array of second pixels to detect a presence of a different fluorophore.

In some embodiments of the first imaging apparatus, the set of optical components comprises a first set of optical components, a second set of optical components, a scanning element, a third set of optical components, and a third objective. The first set of optical components has a proximal end, a distal end, and a first optical axis, and the first set of optical components includes a first objective disposed at the distal end of the first set of optical components. The second set of optical components has a proximal end, a distal end, and a second optical axis, and the second set of optical components includes a second objective disposed at the distal end of the second set of optical components. The scanning element is disposed proximally with respect to the proximal end of the first set of optical components and proximally with respect to the proximal end of the second set of optical components. The scanning element is positioned to route a sheet of excitation light so that the sheet of excitation light will pass through the first set of optical components in a proximal to distal direction and project into a sample that is positioned distally beyond the distal end of the first set of optical components. The sheet of excitation light is projected into the sample at an oblique angle, and the sheet of excitation light is projected into the sample at a position that varies depending on an orientation of the scanning element. The first set of optical components routes detection light from the sample in a distal to proximal direction back to the scanning element. The scanning element is also positioned to route the detection light so that the detection light will pass through the second set of optical components in a proximal to distal direction and form an intermediate image plane at a position that is distally beyond the distal end of the second set of optical components. The third set of optical components is configured to expand each of the plurality of beams of excitation light into the sheet of excitation light. The third objective is positioned to route light arriving from the intermediate image plane towards the image splitter. In these embodiments, the optical beam combiner comprises at least one pair of alignment mirrors configured to facilitate alignment of the plurality of beams of excitation light onto the single common excitation path.

Some embodiments of the first imaging apparatus further comprise the plurality of light sources and the at least one camera, and each of the light sources comprises a laser. Optionally, in these embodiments, the first array of first pixels and the second array of second pixels are located on a single camera sensor chip. Alternatively, in these embodiments, the first array of first pixels and the second array of second pixels can be located on two different camera sensor chips.

In some embodiments of the first imaging apparatus, the plurality of beams of excitation light comprises at least three beams of excitation light, each of which has a different center wavelength.

In some embodiments of the first imaging apparatus, the plurality of beams of excitation light comprises at least three beams of excitation light, each of which has a different center wavelength. In these embodiments, the at least one processor is further programmed to generate a matrix of spectral characterization for a plurality of pixels in the sample from the image data captured during each of the timeslots, and unmix the matrix of spectral characterization to determine which, if any, fluorophores are present in each of the plurality of pixels.

Optionally, in the embodiments described in the previous paragraph, the at least one processor is further programmed to measure an intensity at each first pixel in response to excitation with each of the beams of excitation light, measure an intensity at each second pixel in response to excitation with each of the beams of excitation light, generate an image M (r,λ) with r pixels acquired at wavelength combination λ of a sample containing N fluorophores using the equation

$$M ( r , λ ) = {\sum }_{n = 0}^{N} {c}_{n} ( r ) {f}_{n} ( λ )$$

where cn(r) is the spatial pattern of fluorophore concentrations at each position r, and fn(λ) is the spectral properties of each of the N fluorophores, respectively, for wavelength 1. In these embodiments, the at least one processor is also further programmed to use unmixing to determine which fluorophore or fluorophores is present at each pixel.

In some embodiments of the first imaging apparatus, the plurality of beams of excitation light comprises at least three beams of excitation light, each of which has a different center wavelength. In these embodiments, the at least one processor is further programmed to generate a matrix of spectral characterization for a plurality of pixels in the sample from the image data captured during each of the timeslots, and unmix the matrix of spectral characterization to determine which, if any, fluorophores are present in each of the plurality of pixels. The at least one processor is further programmed to implement unmixing using non-negative least squares fitting.

In some embodiments of the first imaging apparatus, the plurality of beams of excitation light comprises at least five beams of excitation light, each of which has a different center wavelength.

In some embodiments of the first imaging apparatus, the image splitter is configured to route wavelengths of light that are shorter than λ1 towards the first array of first pixels, and to route wavelengths of light that are longer than λ2 towards the second array of second pixels, wherein λ2 is greater than or equal to λ1. These embodiments further comprise at least one first filter positioned in a path of the emission light at a position that precedes the first array of first pixels. The at least one first filter blocks wavelengths of light that correspond to at least one of the beams of excitation light with a center wavelength shorter than λ1. And these embodiments further comprise a second filter positioned in a path of the emission light at a position that precedes the second array of second pixels, wherein the second filter blocks wavelengths of light that correspond to a beam of excitation light with a center wavelength longer than λ2. Optionally, in these embodiments, λ1=λ2=560 nm.

In some embodiments of the first imaging apparatus, the image splitter is configured to route wavelengths of light that are shorter than λ1 towards the first array of first pixels, to route wavelengths of light between λ1 and λ2 towards the second array of second pixels, and to route wavelengths of light that are longer than λ2 towards the first array of first pixels, and λ2 is at least 50 nm larger than λ1. These embodiments further comprise at least one first filter positioned in a path of the emission light at a position that precedes the first array of first pixels, and the at least one first filter blocks wavelengths of light that correspond to at least one of the beams of excitation light with a center wavelength shorter than λ1.

Optionally, the embodiments described in the previous paragraph may further comprise a second filter positioned in a path of the emission light at a position that precedes the second array of second pixels, wherein the second filter blocks wavelengths of light that correspond to a beam of excitation light with a center wavelength between λ1 and λ2.

In some embodiments of the first imaging apparatus, the image splitter is configured to route wavelengths of light between λ1 and λ2 towards the first array of first pixels, to route wavelengths of light between λ2 and λ3 towards the second array of second pixels, to route wavelengths of light between λ3 and λ4 towards the first array of first pixels, and to route wavelengths of light between λ4 and λ5 towards the second array of second pixels, wherein λ5>λ4>λ3>λ2>λ1. These embodiments further comprise at least one first filter positioned in a path of the emission light at a position that precedes the first array of first pixels. The at least one first filter blocks wavelengths of light that correspond to at least one of the beams of excitation light with a center wavelength between λ1 and λ2 or between λ3 and λ4.

Optionally, the embodiments described in the previous paragraph may further comprise a second filter positioned in a path of the emission light at a position that precedes the second array of second pixels. The second filter blocks wavelengths of light that correspond to a beam of excitation light with a center wavelength between λ2 and λ3 or between λ4 and λ5. Optionally, in these embodiments, the beam-splitter, the at least one first filter, and the second filter are all integrated into a single optical component.

Another aspect of this application is directed to a first imaging method. The first imaging method comprises directing a plurality of beams of excitation light that emanate from a respective plurality of light sources onto a single common excitation path, wherein each of the plurality of light sources outputs a respective beam of excitation light that has a respective center wavelength; directing the plurality of beams of excitation light from the single common excitation path into a sample; directing a first set of wavelengths of light emitted by fluorophores within the sample towards a first array of first pixels of at least one camera; and directing a second set of wavelengths of light emitted by fluorophores within the sample towards a second array of second pixels of the at least one camera. The first imaging method also comprises activating each of the plurality of light sources during a respective timeslot; and processing image data captured using the first array of first pixels and/or image data captured using the second array of second pixels during each of the timeslots. For at least one of the timeslots, the processing of the image data comprises using the image data captured using the first array of first pixels to detect a presence of a given fluorophore, and using the image data captured using the second array of second pixels to detect a presence of a different fluorophore.

In some instances of the first imaging method, the first array of first pixels and the second array of second pixels are located on a single camera sensor chip.

In some instances of the first imaging method, the plurality of beams of excitation light comprises at least three beams of excitation light, each of which has a different center wavelength.

In some instances of the first imaging method, the plurality of beams of excitation light comprises at least three beams of excitation light, each of which has a different center wavelength. These instances further comprise generating a matrix of spectral characterization for a plurality of pixels in the sample from the image data captured during each of the timeslots, and unmixing the matrix of spectral characterization to determine which, if any, fluorophores are present in each of the plurality of pixels.

Optionally, the instances described in the previous paragraph may further comprise measuring an intensity at each first pixel in response to excitation with each of the beams of excitation light, measuring an intensity at each second pixel in response to excitation with each of the beams of excitation light, generating an image M(r,λ) with r pixels acquired at wavelength combination λ of a sample containing N fluorophores using the equation

$$M ( r , λ ) = {\sum }_{n = 0}^{N} {c}_{n} ( r ) {f}_{n} ( λ )$$

where cn(r) is the spatial pattern of fluorophore concentrations at each position r, and fn(λ) is the spectral properties of each of the N fluorophores, respectively, for wavelength 1, and using unmixing to determine which fluorophore or fluorophores is present at each pixel.

In some instances of the first imaging method, the plurality of beams of excitation light comprises at least three beams of excitation light, each of which has a different center wavelength. These instances further comprise generating a matrix of spectral characterization for a plurality of pixels in the sample from the image data captured during each of the timeslots, and unmixing the matrix of spectral characterization to determine which, if any, fluorophores are present in each of the plurality of pixels. These instances further comprise implementing unmixing using non-negative least squares fitting.

In some instances of the first imaging method, the plurality of beams of excitation light comprises at least five beams of excitation light, each of which has a different center wavelength.

### BRIEF DESCRIPTION OF THE DRAWINGS

FIG. 1 is a schematic representation of a SCAPE embodiment that provides higher resolutions than prior art SCAPE systems.

FIG. 2 depicts how certain lasers simultaneously excite emissions in certain channels from multiple fluorophores.

FIG. 3A depicts how unmixing can be used to detect multiple fluorophores.

FIG. 3B shows that the FIG. 3A unmixing approach is tolerant of noise in the input data.

FIG. 4A depicts a phasor-based spectral encoding approach that relies on two sinusoids.

FIG. 4B depicts a phasor-based spectral encoding approach that relies on four sinusoids.

FIG. 4C shows that, for a multitude of fluorescent agents, one can simulate what we would measure through the four sinusoidal filters with passbands as shown in FIG. 4B.

FIG. 4D shows that stacked notch or multi-notch filters are used to block illumination wavelengths.

FIG. 4E shows that after incorporating the transmission spectra of the notch filters, one can predict the signals detected in the four spectral phasor channels for each excitation laser wavelength.

FIG. 4F shows the result of unmixing using non-negative least squares fitting on the data from the right panel of FIG. 4E.

FIG. 4G shows unmixing of overlapping regions that represent linear combinations of different fluorophores.

FIG. 4H shows that the FIG. 4G result can still be achieved with the addition of noise.

FIG. 4I shows an image splitter design that incorporates sinusoidal and cosine spectral filters to provides efficient splitting of the light into four useful phasor components.

FIG. 4J depicts the components resulting from the FIG. 4I image splitter design.

FIG. 4K shows that the wavelength-frequency of the cosine/sine filters for fluorescence sets can be adjusted to ensure uniqueness.

FIG. 4L shows how filters with reciprocity provide efficient light collection.

FIG. 5 shows the clustering of data into groups based on the relative labeling levels of the range of fluorophores present.

FIG. 6A shows how the position of the image splitter has been moved from the traditional location to a new location for the FIG. 1 embodiment.

FIG. 6B shows a set of workable parameters for the relay lens telescope of the FIG. 1 embodiment.

FIG. 6C depicts what the output beam diameter will be at a distance of 165 mm for two different combinations of lenses when used in the FIG. 1 embodiment.

FIG. 6D shows what the field of view will be for three different lenses when used in the FIG. 1 embodiment.

FIG. 7A depicts a horizontal image splitter configuration that has traditionally been used in SCAPE systems.

FIG. 7B depicts a vertical image splitter configuration that can be used in connection with the FIG. 1 embodiment.

FIG. 7C shows how a lens telescope in the third arm of the system can be used to compress Z to decrease the number of camera rows required.

FIG. 8A depicts an image splitter configuration that uses two cameras with four emission channels.

FIG. 8B depicts a single-camera image splitter configuration that uses four-way image splitting using three different dichroic filters.

FIG. 9A is a table showing a range of possible imaging configurations for imaging large spherical samples such as a human brain.

FIG. 9B depicts results of image splitting at two different magnifications onto two separate cameras.

FIG. 9C depicts how additional color channels can be imaged at two different magnifications onto two separate cameras.

FIG. 9D depicts how multiple color channels can be imaged at two different magnifications onto a single camera.

FIG. 10A depicts using spectral data for image registration.

FIG. 10B depicts tracking based in spectral key-frames.

FIGS. 11A and 11B depict incorporating a diffractive element into the system to generate spatially dependent but overlapping spectral encoding in the detected image.

FIG. 12A depicts a first embodiment that provides 3D, high-speed imaging over large fields of view.

FIG. 12B depicts a second embodiment that provides 3D, high-speed imaging over large fields of view.

FIG. 12C depicts a detail of the FIG. 12B embodiment.

FIG. 12D depicts a variation on the FIG. 12B embodiment.

FIG. 13A depicts how a tapered fused fiber bundle with the ground edge can be used to achieve image rotation without requiring a steep acceptance angle.

FIG. 13B depicts how the FIG. 13A component can be used to implement an imaging system.

FIG. 13 C depicts alternative approaches for coupling light into the third objective.

FIG. 13D depicts how two refracted marginal rays can be made symmetric relative to the fiber axis, thus minimizing the overall angle of output light cone.

FIG. 14A shows how a grating can be arranged so that that it overlaps with the sheet angle.

FIG. 14B depicts geometric details of the FIG. 14A embodiment.

FIG. 15A depicts how SCAPE geometries compares to ‘di-SPIM’ angled geometries.

FIGS. 15B(i-iv) depict how moving the sample to different distances away from the objective lens can reposition the waist of the beam to different depths.

FIG. 15B(v) shows how over a more limited range, this adjustment of Z position could also be achieved by adding a tunable lens element to the O1 telescope arm.

FIG. 15C depicts how an extended usable depth range can be obtained in a SCAPE system.

FIG. 15D depicts a SCAPE embodiment for imaging very large, cleared, thick samples such as processed human brain.

FIG. 15E depicts another SCAPE embodiment that uses a multi-immersion lens and has the ability to image to depths of over 8 mm in cleared samples.

FIG. 15F depicts a system for imaging an entire human brain.

FIG. 15G shows how image acquisition can be speeded up through parallelization of imaging.

FIGS. 16A-16E depict five different possible geometries for the light sheet.

Various embodiments are described in detail below with reference to the accompanying drawings, wherein like reference numerals represent like elements.

### DESCRIPTION OF THE PREFERRED EMBODIMENTS

This application describes a number of improvements to SCAPE systems and/or alternative approaches for implementing a SCAPE system. As used herein: O1, O2, and O3 respectively refer to the first, second, and third objectives in a SCAPE system from sample to detector. The following acronyms are used herein: ZWD=zero working distance; FOV=field of view; NA=numerical aperture; NIR=near infrared; GDD=group delay dispersion; PSF=point spread function; and WD=working distance.

### Section 1

### A SCAPE Design for Multispectral Imaging

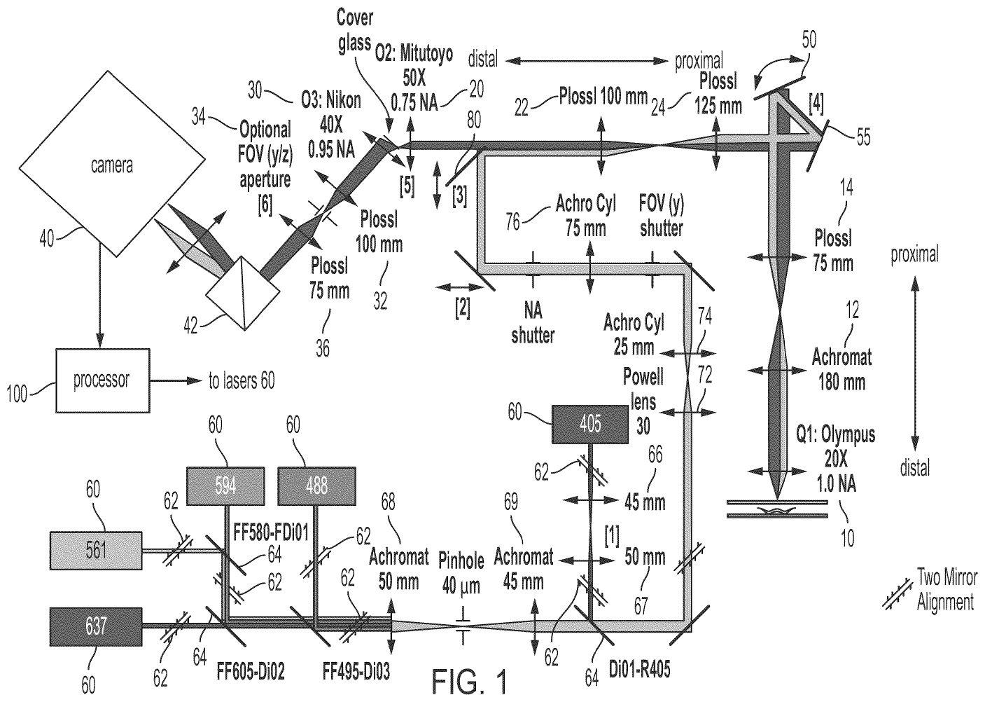

FIG. 1 is a schematic representation of a SCAPE embodiment designed primarily for multispectral imaging of C. elegans worms, but with applicability to cellular imaging, in-situ sequencing, expansion-seq and other imaging applications such as histopathology in fresh tissues. SCAPE has a super-fast parallel nature and is very useful for performing want 3D imaging of live organisms. The FIG. 1 design has a much higher resolution than many prior SCAPE systems while maintaining a relatively large field of view, with high detection NA using two air-immersion lenses as O2 and O3, and higher throughput.

The FIG. 1 embodiment includes a first set of optical components 10-14 having a proximal end, a distal end, and a first optical axis. The first set of optical components includes a first objective 10 disposed at the distal end of the first set of optical components. The FIG. 1 embodiment also includes a second set of optical components λ0-24 having a proximal end, a distal end, and a second optical axis. The second set of optical components includes a second objective 20 disposed at the distal end of the second set of optical components. And the FIG. 1 embodiment also includes a scanning element 50 that is disposed proximally with respect to the proximal end of the first set of optical components 10-14 and proximally with respect to the proximal end of the second set of optical components λ0-24.

The scanning element 50 is positioned to route a sheet of excitation light so that the sheet of excitation light will pass through the first set of optical components 10-14 in a proximal to distal direction and project into a sample that is positioned distally beyond the distal end of the first set of optical components 10-14. The sheet of excitation light is projected into the sample at an oblique angle, and the sheet of excitation light is projected into the sample at a position that varies depending on an orientation of the scanning element.

The first set of optical components 10-14 routes detection light from the sample in a distal to proximal direction back to the scanning element 50. The scanning element 50 is also positioned to route the detection light so that the detection light will pass through the second set of optical components 20-24 in a proximal to distal direction and form an intermediate image plane at a position that is distally beyond the distal end of the second set of optical components (i.e., to the left of the second objective 20 in FIG. 1).

In the embodiment illustrated in FIG. 1, a third objective 30 is positioned to route light arriving from the intermediate image plane towards a camera 40. The camera can include a high speed, intensified or otherwise amplified camera to permit imaging at very high frame rates, and thus achieve very fine sampling during scanning across a large field of view to deliver both high-resolution in 3 dimensions and very fast imaging speeds with high signal to noise and low photobleaching.

The embodiment illustrated in FIG. 1 includes a plurality of light sources 60 (e.g., lasers), each having a respective output beam at a respective wavelength. It also includes at least one optical beam combiner 64 positioned with respect to the plurality of light sources 60 to route the output beams from the plurality of light sources onto a common path of excitation light. At least one pair of alignment mirrors 62 are provided. Each pair of alignment mirrors is positioned with respect to a respective light source 60 to adjust an alignment of a respective output beam (e.g., by adjusting beam angle and position). These pairs of alignment mirrors 62 are used to align all the output beams so that they are aligned within the sample. In the illustrated embodiment, the light path from the 405 nm light source 60 passes through the lenses 66 and 67; and the light path from all the other light sources 60 pass through the lenses 68 and 69 and a 40 μm pinhole positioned between those two lenses.

Optionally, the laser combiner can include one or more lens systems or other wavefront adjustment systems to adjust the beam size, divergence, or convergence of the output of individual laser sources 60 prior to their arrival onto the common path so that they become aligned within the sample. In combination with alignment mirrors 62 this additional degree of freedom may be needed to pre-compensate for chromatic aberrations and effects within the lens system which could lead to misalignment of the illuminating light sheet from each laser wavelength at the sample. This pre-compensation requires free-space coupling of the combined laser wavelengths into the downstream optical system and could not be readily achieved if laser wavelengths were combined and routed through a fiber optic coupler which is common for other multispectral microscope systems. This approach enables very fast or simultaneous multi-spectral imaging by not requiring sequential adjustment of beam properties for each illumination wavelength.

A third set of optical components 72-76 is configured to expand the output beams into a sheet of excitation light. But in alternative embodiments, the sheet of excitation light could be formed by scanning the combined output beams using a galvanometer (not shown). The sheet of excitation light arrives at the scanning element 50 via the second set of optical components 20-24. More specifically, in the embodiment illustrated in FIG. 1, the sheet of excitation light is introduced into the second set of optical components via a second mirror 80 that is positioned proximally with respect to the second objective λ0. This second mirror 80 is positioned to accept the sheet of excitation light from the third set of optical components 72-76 and reroute the sheet of excitation light towards the proximal end of the second set of optical components λ0-24. In some preferred embodiments, the second mirror 80 has a beveled straight first edge 81 and at least one second edge 82, mounted such that the beveled straight first edge is closer to the second optical axis than the at least one second edge. This second mirror 80 advantageously facilitates the use of many wavelengths because it does not include a dichroic beam splitter in the main light path.

Optionally, the second mirror 80 can be mounted on a translation stage that provides precise control of the position of the second mirror 80 in a direction perpendicular to the optical axis of the second set of components λ0-24, as illustrated by the vertical arrow next to the second mirror 80 in FIG. 1.

In the embodiment illustrated in FIG. 1, the scanning element 50 is mounted at an angle that deviates by 22.5° from perpendicular to the first optical axis, and a folding mirror 55 is disposed between the scanning element and the second set of optical components 20-24. But in alternative embodiments (not shown), the position of the scanning element 50 and the folding mirror 55 can be swapped, in which case the scanning element 50 would be mounted at an angle that deviates by 22.5° from perpendicular to the second optical axis, and the folding mirror 55 would be disposed between the scanning element 50 and the first set of optical components. The embodiments described in this paragraph advantageously increase the effective aperture with respect to the conventional approach in which the folding mirror 55 is omitted, and the scanning element is mounted at a 45° angle with respect to both the second optical axis and the first optical axis.

Optionally, a cage system swivel mount (e.g., Thorlabs LCIA) can be provided for precise and easy alignment between the two telescope arms (i.e., positioned between O2 and O3). Alignment can also be optimized using real-time camera-based visualization of O2 and O3 from above, overlaid with an image showing the simulation-derived ideal angle and positioning. When O3 is implemented using the 40× 0.95 NA lens depicted in FIG. 1, a coverglass is preferably carefully positioned in front of O3 to account for the coverglass correction needed for the 40× 0.95 NA lens.

Optionally, a relay lens telescope 32, 36 positioned after O3 can be provided to project a conjugate plane of the back focal plane of O3 into the image splitter 42. This offers a larger FOV with better image uniformity. In addition, the creation of an intermediate image plane enables image cropping in both Y and Z, which can be important for placement of dual channel spectrally resolved images on the camera 40. The image splitter 42 is configured to route a first set of wavelengths of light towards a first array of pixels in the camera 40 and to route a second set of wavelengths of light towards a second array of pixels in the camera 40.

Table 1 lists a set of components that work well in the FIG. 1 embodiment, and table 2 lists the distances between the centers of the various components that appear in FIG. 1.

TABLE 1

| Ref. no. | Company | Part no. |
|---|---|---|
| 12 | Thorlabs | AC508-180-A |
| 14 | Thorlabs | AC508-150-A |
| 22 | Edmund Optics | #49-286 |
| 24 | Thorlabs | AC508-250-A, AC508-300-A |
| 32 | Thorlabs | AC508-200-A |
| 36 | Thorlabs | AC508-150-A |
| 66 | Thorlabs | AC254-045-A |
| 67 | Thorlabs | AC254-050-A |
| 68 | Thorlabs | AC254-050-A |
| 69 | Thorlabs | AC254-045-A |
| 72 | Laserline Optics Canada | LOCP-8.9R30-1.0 |
| 74 | Edmund Optics | #68-160 |
| 76 | Thorlabs | ACY254-075-A |

TABLE 2

| Ref. nos. | Distance between centers in mm |
|---|---|
| 10, 12 | 130 |
| 12, 14 | 226 |
| 14, 50 | 57 |
| 50, 55 | 40 |
| 55, 24 | 75 |
| 22, 24 | 210 |
| 20, 22 | 80 |
| 30, 32 | 75 |
| 32, 36 | 163 |
| 68, 69 | 80 |
| 72, 74 | 20 |

### Section 2

### High-Speed Spectral Multiplexing

### Section 2.1—The Excitation Side

Traditional SCAPE systems have typically used a two-color image splitter for emission wavelengths (separating >560 nm from <560 nm), either using just 488 nm excitation or 488 nm +561 nm excitation to excite green and red emitting fluorophores. These systems use band-pass filters as emission filters within the image splitter to isolate the green and red emission bands.

In embodiments of SCAPE like the FIG. 1 embodiment, combinations of laser illumination wavelengths and emission filters permit near-simultaneous imaging of many different fluorophores within the sample with no moving parts. These embodiments can use a D-shaped mirror as the mirror 80 to launch the light sheet into the system at a different location compared to traditional dichroic mixing/separation of excitation and emission light. This D-shaped mirror is formed by cutting a conventional round mirror in half, so that each half will have the beneficial properties over a standard mirror of being uniform and high quality at its center (edge), providing a wedge shape to permit its angled insertion into the light path without additional losses, and having enough vertical extent to reflect an incoming light-sheet forming laser beam in the form of a vertical line.

The mirror 80 should be placed within the light path in such a way that the backside of the mirror is hidden from clipping the beam. Therefore, it should be rotated with an angle larger than 90−30=60°. The mirror 80 can be mounted on a translation stage to ensure that all of the illumination light gets in, while blocking the minimum amount of detection light.

The D-shaped mirror 80 advantageously provides wavelength independence, which permits the use of arbitrary lasers. In some preferred embodiments, the coating extends to within 0.05 mm of the straight edge of the mirror, which avoids clipping on the Fourier plane.

Only a small amount of O2's aperture is obscured here by the D-shaped mirror, permitting most of the fluorescent light to reach the intermediate image plane. Positioning this D-shaped mirror as depicted in FIG. 1 permits adjustment of the position of the beam at the back of O1 and thus sheet angle. Using a mirror means that there is no wavelength dependence for excitation and emission light and also no aberration introduced or light lost by a multi-line dichroic in the main system.

Expanded spectral imaging is achieved by adding additional laser sources 60 to the system and adding filter sets that facilitate the imaging of multiple fluorophores. To maintain SCAPE's imaging speeds, these embodiments do not require any physical movement or switching of filters.

FIG. 1 depicts a preferred approach for merging the beams from the incoming lasers 60 sources (each of which has a respective center wavelength) onto a single common excitation path. Preferably, all of the incoming laser wavelengths are precisely aligned. In the case of the 405 nm laser in particular, it is preferable to be able to independently adjust its collimation to account for differences in divergence and chromatic aberrations in the system to ensure that the final sheet at the sample is exactly aligned for all illumination colors. For this reason, the beam from the 405 nm laser is added in to the common path after all the other laser beams have been added. Each laser 60 is electronically modulatable permitting rapid switching on and off in any arbitrary sequence at >kHz rates based on signals that arrive from the processor 100. For SCAPE this means we can cycle through each laser for each position of the galvo 5055 (or while the galvo 50 is moving and interpolate) or switch lasers in between successive volumes. Thus far the latter approach appears to be preferable.

### Section 2.2—The Emission Side

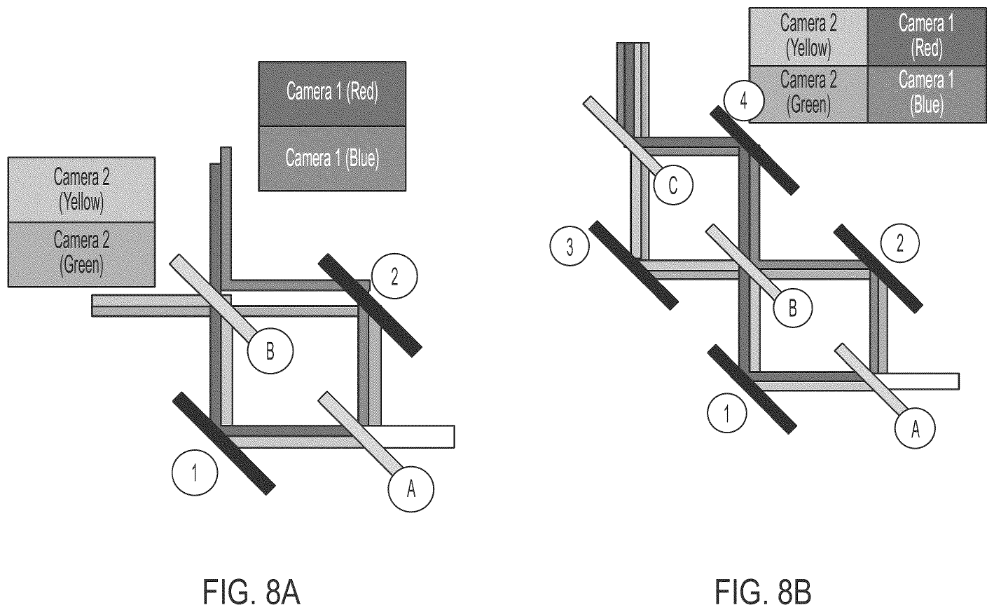

Although it is possible to generate more than two split images onto the camera 40 using modified image splitter designs (e.g., using the configuration described below in connection with FIGS. 8A and 8B), with each laser dedicated to only a single fluorophore, this would reduce maximum imaging speeds overall and could be less efficient and more costly. An alternative is to design the image splitter 42 in FIG. 1 using an emission filter set that can permit imaging with all lasers either in parallel or in series and minimally two spectrally resolved detected images, and having at least some of the lasers activate more than one fluorophore.

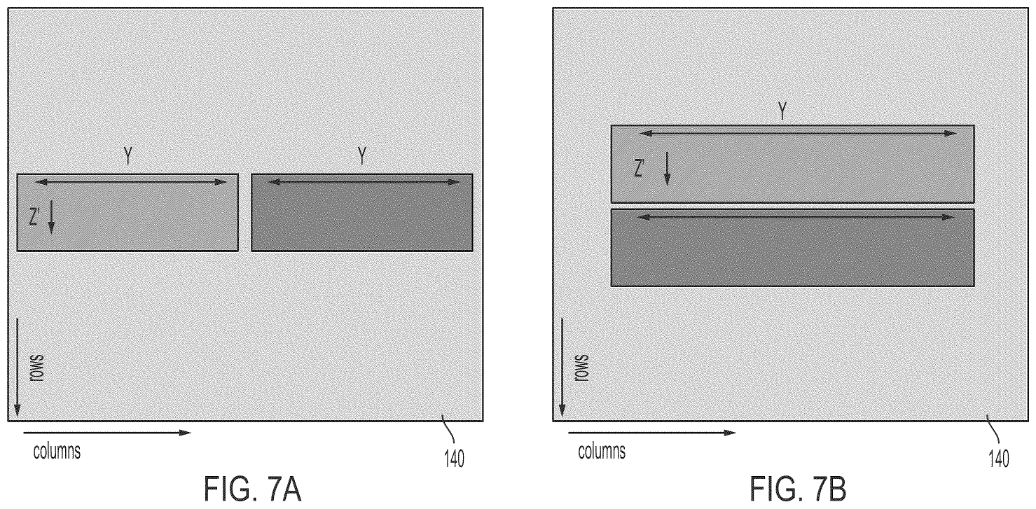

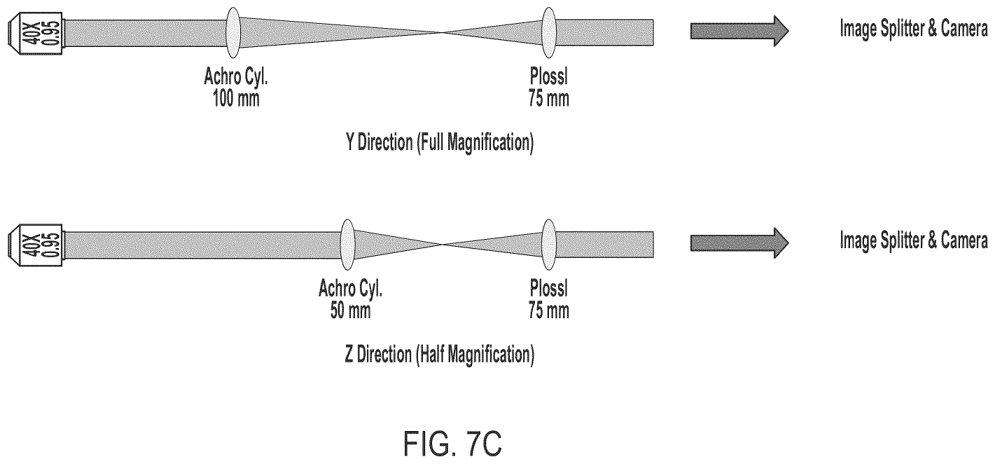

In the three examples described below, the image splitter 42 separates the incoming light into two spectrally resolved detected images, and both of these images are captured by different regions on a single camera chip, e.g., as described below in connection with FIGS. 7A and 7B. Each of these regions is referred to herein as a channel, and each channel will image a different set of wavelengths. The images captured in each channel are processed by the processor 100 to determine which pixels of each image received light during each time slot (with each timeslot corresponding to the activation of a respective one of the light sources 60), and how much light was received. Note that in alternative embodiments (not shown), instead of capturing both channels in a single camera, the two channels can be captured in two different cameras.

The image splitter 42 can be implemented using a dichroic filter that directs certain wavelengths towards one channel and directs other wavelengths towards the other channel. Additional wavelength-selective filters (e.g., notch filters) can be positioned between the dichroic image-splitting filter and each camera channel to prevent the excitation light from reaching the respective camera channel. In alternative embodiments, some or all of the filters that suppress the excitation light can be positioned prior to the dichroic image-splitting filter instead of after that filter.

The following five fluorophores are all expressed in a C. elegans worm that the inventors are studying: TAGBF, EGF, CyOF, TagRF, and mNeptune2. It would be advantageous to image them all as quickly as possible. We shall now present three examples in which all five of these fluorophores can be detected using fewer than five lasers.

In the first example, the image splitter 42 directs wavelengths below 560 nm to channel 1, and directs wavelengths above 560 nm to channel 2. Before the light that exits the image splitter arrives at channel 1, it passes through a filter that only passes light at 428-473 nm and 502-538 nm (e.g., a Semrock FF01-449/520-25). And before the light that exits the image splitter arrives at channel 2, it passes through a filter that only passes light at 560-610 nm and 665-740 nm (e.g., a Chroma 59007m). With this arrangement, the 405 nm laser can excite an emission in both the 428-473 nm and 502-538 nm pass bands in channel 1, and both the 560-610 nm and 665-740 nm passbands in channel 2; the 488 nm laser can excite an emission in the 502-538 nm pass band in channel 1 and both the 560-610 nm and 665-740 nm passbands in channel 2; the 561 nm laser can excite an emission in both the 560-610 nm and 665-740 nm passbands in channel 2; the 594 nm laser can excite an emission in the 560-610 nm (>594 only) and 665-740 nm passbands in channel 2; and the 637 nm laser can excite an emission in only the 665-740 nm passband in channel 2. This situation is summarized in table 3 below:

TABLE 3

| | Emission 1 | Emission 2 |
|---|---|---|
| 405 nm | 428-473/502-538 | 560-610/665-740 |
| 488 nm | 502-538 | 560-610/665-740 |
| 561 nm | | 560-610/665-740 |
| 594 nm | | 594-610/665-740 |
| 637 nm | | 665-740 |

In the second example, the image splitter 42 uses a dual-band dichroic to directs wavelengths of 405-560 nm and 600-650 nm to channel 1, and directs wavelengths of 560-600 nm and 650-750 nm to channel 2. Before the light that exits the image splitter arrives at channel 1, it passes through a multi-notch filter that blocks all laser wavelengths within the channel 1 passbands; and before the light that exits the image splitter arrives at channel 2, it passes through a multi-notch filter that blocks all laser wavelengths within the channel 2 passbands. With this arrangement, the 405, 488, 561, 594, and 637 nm lasers can excite emissions that can be detected in channel 1 and channel 2 as set forth in table 4, below:

TABLE 4

| | emission 1 | emission 2 |
|---|---|---|
| 405 nm | 405-560 + 600-650 | 560-600, 650-750 |
| 488 nm | 490-560 + 600-650 | 560-600, 650-750 |
| 561 nm | 600-650 | 560-600, 650-750 |
| 594 nm | 600-650 | 650-750 |
| 637 nm | — | 650-750 |

Using these five wavelength lasers with an image splitter with the passbands noted above for channel 1 and channel 2 permits both channels to be used for multiple wavelength ranges. This means that illumination with each of the five different-wavelength lasers in turn will generate a ˜9 element matrix of spectral characterization of each pixel in the sample. This kind of spectral fingerprinting can unmix many different fluorophores with ‘no moving parts’ multiplexing i.e., just by switching on and off the various lasers 60 at different times, measuring the returns on the different channels of the camera 40, and subsequently performing unmixing (e.g., in the processor 100) to figure out which fluorophores are present at each pixel.

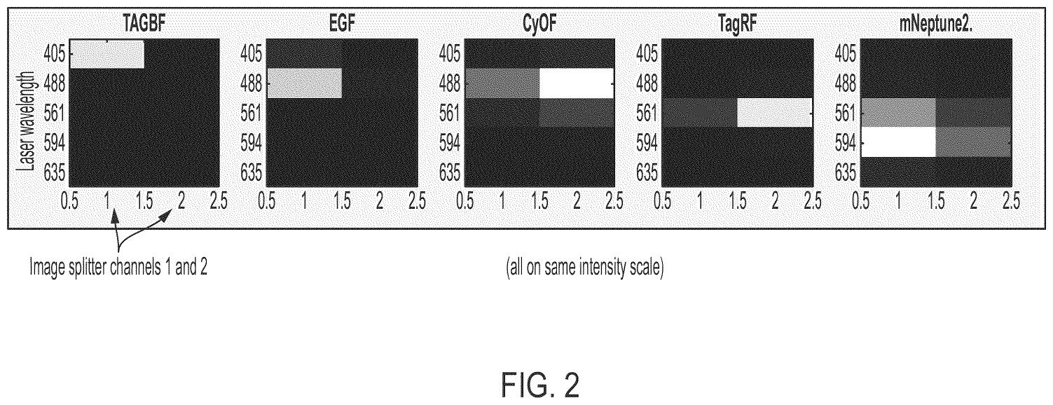

In the third example, the image splitter 42 uses a dichroic filter (e.g., a Semrock FF570-Di01) to direct wavelengths of 570-670 nm to channel 2, and to direct wavelengths below 570 and above 670 to channel 1. Here again, before the light that exits the image splitter arrives at channel 1, it passes through a multi-notch filter that blocks all laser wavelengths within the channel 1 passbands; and before the light that exits the image splitter arrives at channel 2, it passes through a bandpass filter that only passes 570-625 nm (plus an optional additional 594 nm notch in channel 2 in those embodiments where a 594 nm laser is used). With this arrangement, the 405, 488, 561, 594, and 637 nm lasers can excite emissions that can be detected in channel 1 and channel 2 as depicted in FIG. λ. Notably, as seen in FIG. 2, the 488 nm laser will simultaneously excite emissions in channel 1 from both the EGF and CyOF fluorophores, and will also simultaneously excite emissions in channel 2 from the CyOF fluorophore. Similarly, the 561 nm laser will simultaneously excite emissions in channel 1 from the TagRF fluorophore, and will also simultaneously excite emissions in channel 2 from both the CyOF and TagRF fluorophores.

This arrangement enables detection of more fluorophores with fewer lasers. Redundancy in information for the mNeptune fluorophore reveals that it can be detected using 561 nm excitation and separated from TagRFP, removing the need to use either the 594 and 635 nm lasers, thereby removing the need for the 594 nm notch filter, and greatly improving detection efficiency for CyOF and TagRFP. This means that all five fluorophores can be detected using only three lasers which are illuminated in turn. And using only three lasers (as opposed to 4 or 5) can significantly improve imaging speed.

Notably, in these three examples, it will often be the case that a single laser will generate a response from one fluorophore in one channel and a second fluorophore in the other channel, or from two different fluorophores within a single channel. But this is not problematic because a determination of which fluorophore is present at which pixel can be obtained by spectral unmixing or phaser-based unmixing, as described below. This stands in stark contrast to the conventional approach in which the designers strive to ensure that a single laser will only excite a single fluorophore.

Use of laser modulation and emission filters enables capturing hyperspectral (excitation-emission matrix) imaging of each pixel as described herein, particularly using both channels to encode different wavelength bands can be used to generate an ‘excitation-emission map’ for each pixel with no moving parts and minimal laser switching.

### Section 3

### Spectral Unmixing

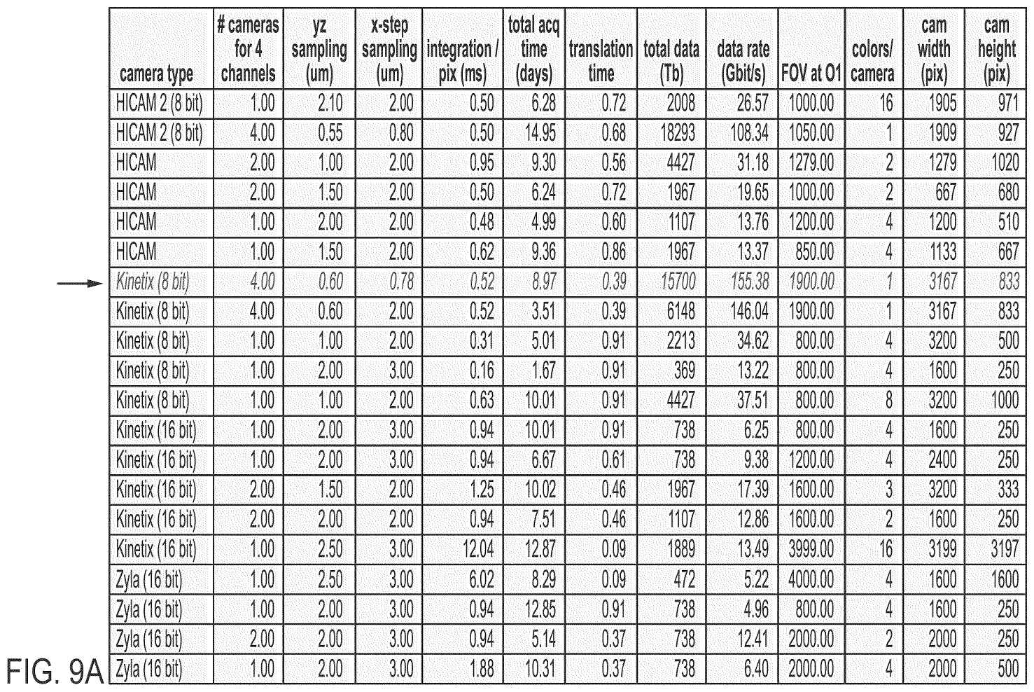

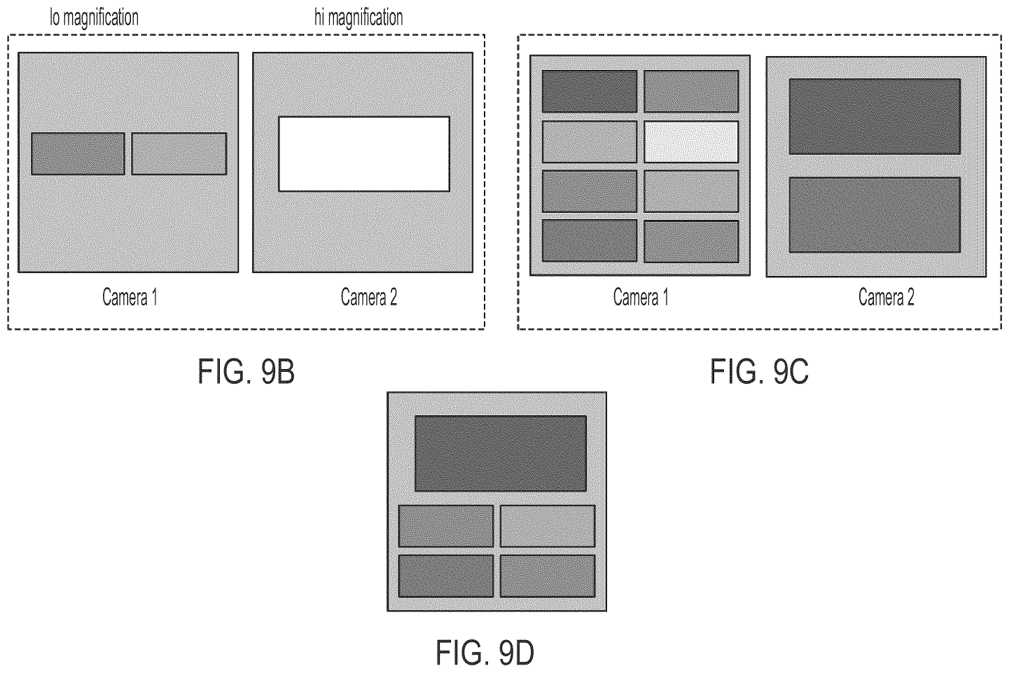

Spectral unmixing can separate a wide range of colors. In some cases, different combinations of two fluorophores (at different concentrations) can encode the identity of a large number of different cells with only λdetection channels by encoding in different ratios. Excitation-emission maps can also permit unmixing of even noisy data with fewer emission channels than fluorophores, as depicted in FIGS. 9A and 9B. Acquiring spectrally close or even overlapping channels (which maximizes light throughput) is not a problem if the fluorophore spectra are known or can be measured or extracted from the image. Unmixing can reduce image noise because it incorporates spectral priors (constraining the solution) while effectively combining information across several channels).

More specifically, rather than attempting to isolate signal in one specific channel (ex−em=excitation-emission pair) for one dye (which wastes a lot of light) we can collect the ex-em fingerprint of each fluorophore and unambiguously unmix it from the data set.

With an image M(r,2) with r pixels acquired at wavelength combination A of a sample containing N fluorophores, the relevant equation is:

$$M ( r , λ ) = {\sum }_{n = 0}^{N} {c}_{n} ( r ) {f}_{n} ( λ )$$

Where cₙ(r) is the spatial pattern of fluorophore concentrations and fₙ(λ) are the spectral properties of the fluorophores. So if you have knowledge of the spectral properties of your fluorophores fₙ(λ) you can solve M(r, λ) for cₙ(r). fₙ(λ) can be a combination of spectral properties including different emissions at different excitation wavelengths (e.g., it can be an excitation-emission map).

By combining matrix inversion with correlation and clustering the optimal fluorophores and spectral measurements to unmix as many fluorophores (or combinations of fluorophores) as possible can be determined. This approach is demonstrated in the simulation in FIG. A, wherein input data assumes an image with squares of each of the following five fluorophores: TAGBF, EGF, CyOF, TagRF, and mNeptune2. Data expected is simulated assuming two spectrally-resolved detector channels, where channel 1 is <570 nm (short-pass or SP) and channel 2 is >570 nm (long-pass or LP) for all 5 excitation lasers (405, 488, 561, 594 and 635 nm). Although each image contains signal from multiple fluorophores, with knowledge of their spectral properties we can use non-negative least squares fitting to cleanly unmix the location of each fluorophore from these simulated measurements.

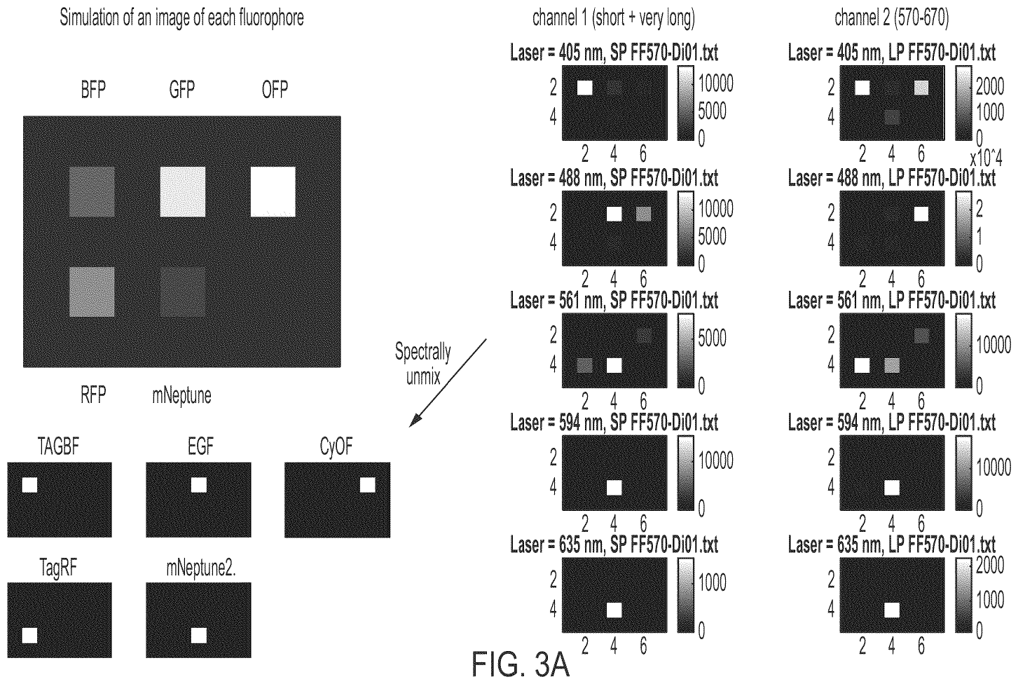

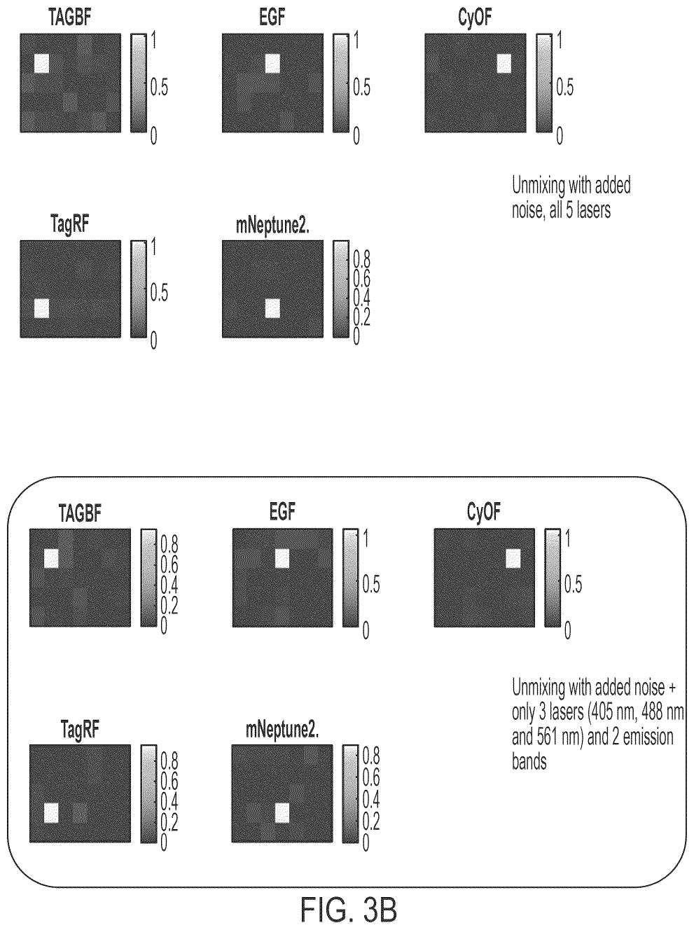

FIG. 3B shows that this unmixing method is tolerant of added (simulated) noise in the input data. A second result shows that with added noise, and only using signals generated from 3 lasers (405, 488 and 561 nm) the locations of each fluorophore can again be unmixed. Although these models show unitary concentrations of fluorophores, this approach also works to calculate the concentration of a fluorophore and can also detect and unmix spatially overlapping concentrations of two or more fluorophores.

Some strategies in biology combine expression/binding of different levels of fewer fluorophores to generate unique cell identities. These identities can be considered unmixing endpoints instead of just identifying each fluorophore (see also section 5 below).

These multiplexing and unmixing strategies can be applied across the spectral range, including for near infrared (NIR) fluorophores. Autofluorescence in tissues can be high at visible wavelengths. Although conventional fluorescence microscopy/immunohistochemistry has mostly used fluors in the visible range, moving to the red and NIR range for spectral multiplexing can be advantageous for digital microscopy to provide more spectral space as well as lower scattering and autofluorescence for spectral imaging and unmixing. This approach can feasibly leverage lenses designed for two-photon microscopy in some cases. Many laser sources are available from telecommunications, while new fluors are emerging. Tissue has lower scattering and absorption. Objective lenses optimized for two-photon microscopy can be used. Spectral unmixing in NIR fluors can also be used for multiplexed immunohistochemistry in cleared human brain tissue.

### Section 4

### Phasor-Based Spectral Multiplexing and Unmixing

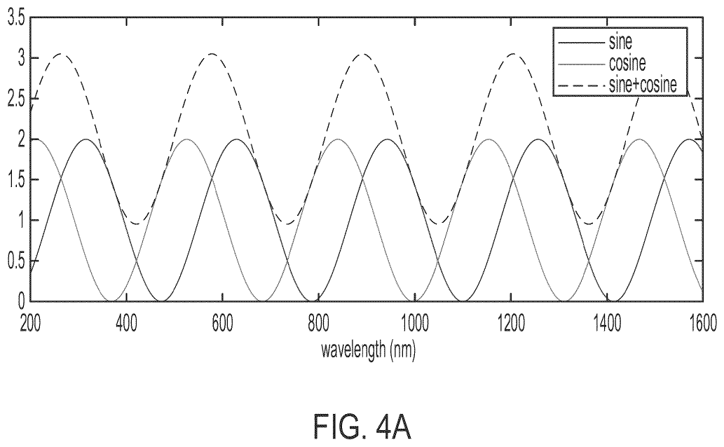

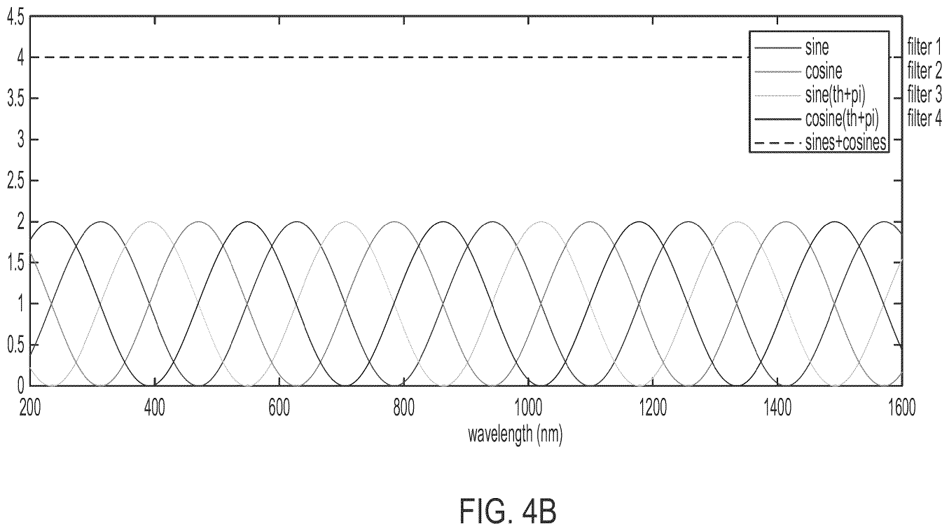

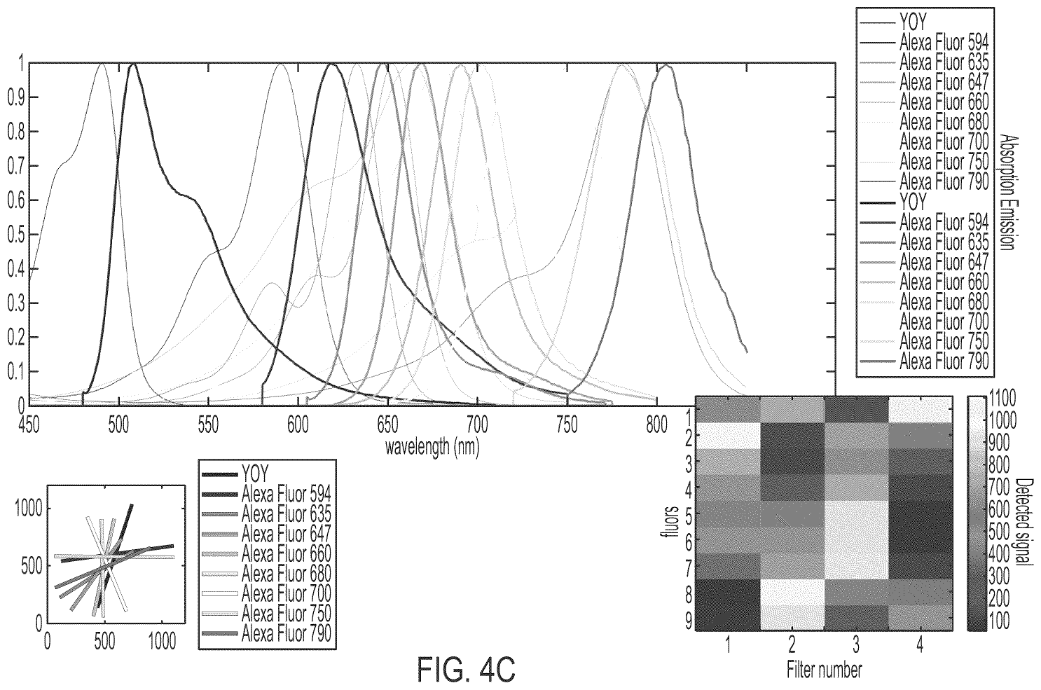

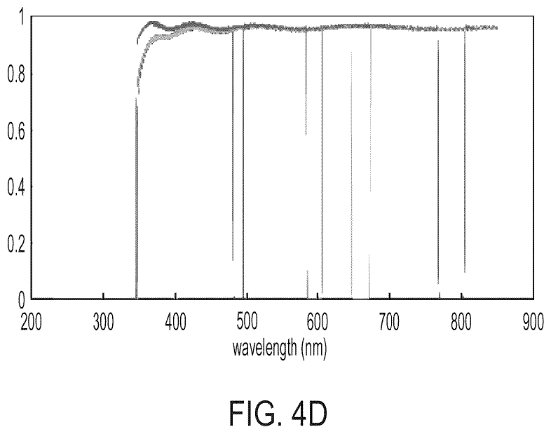

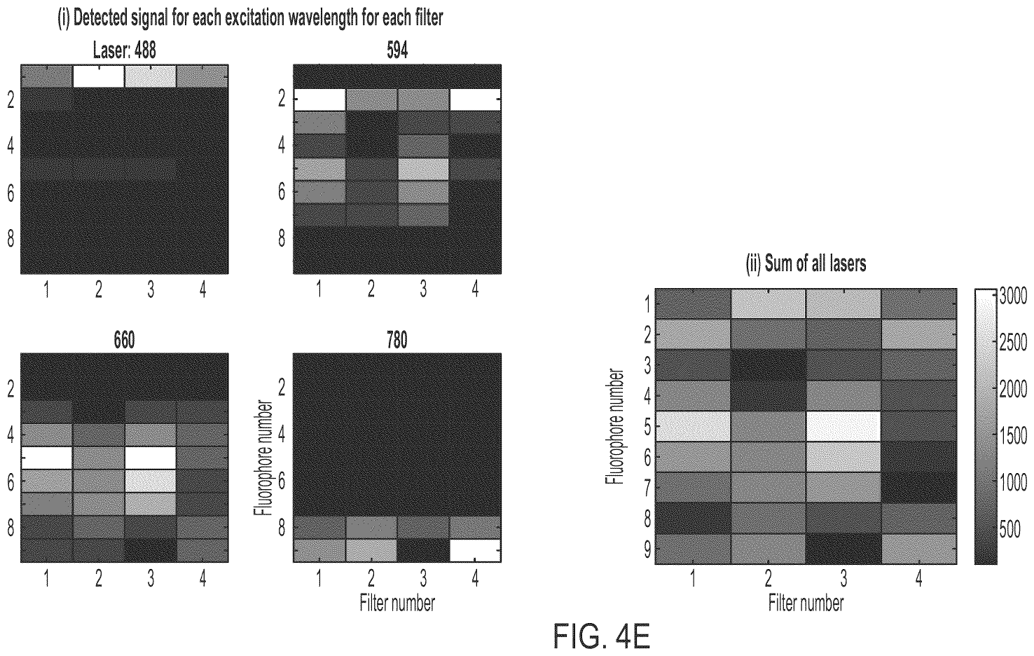

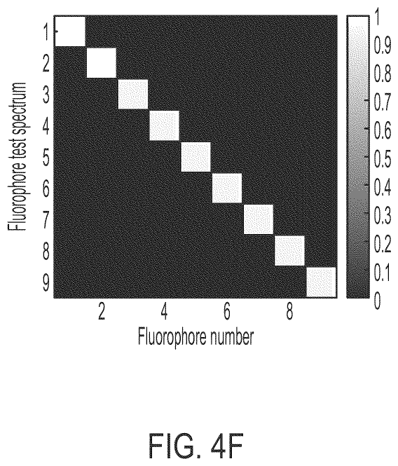

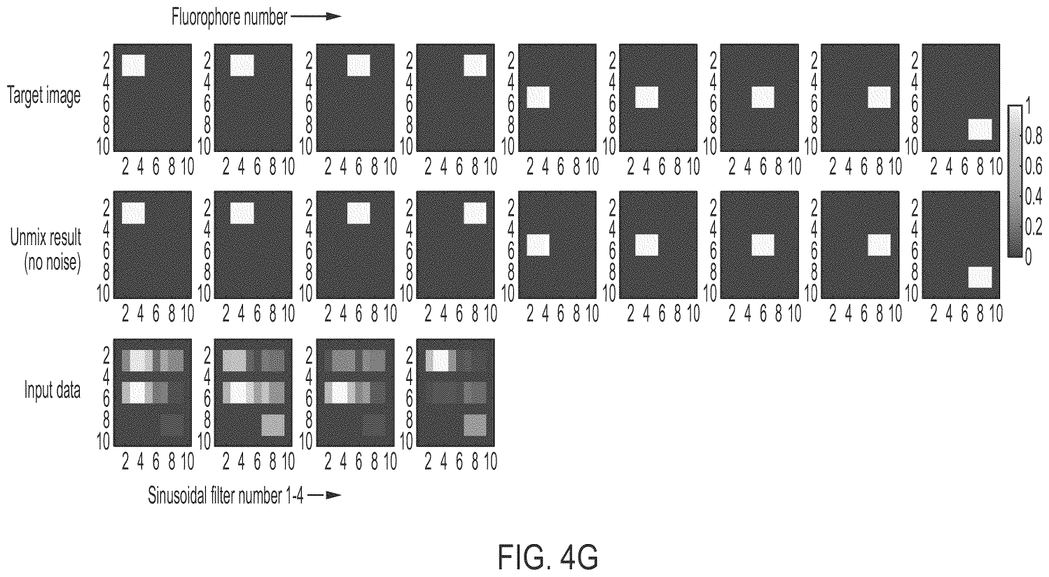

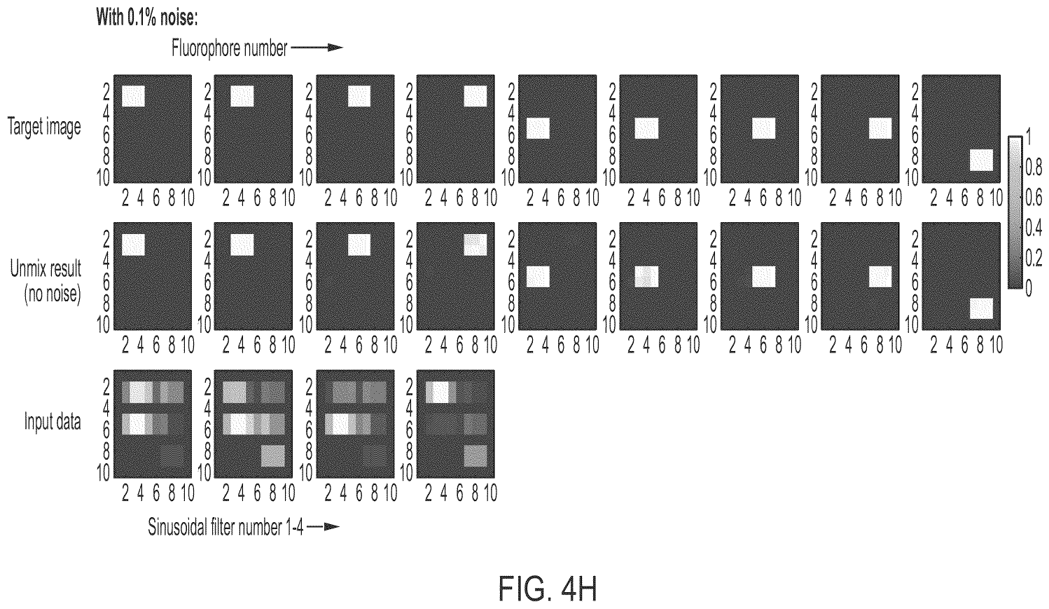

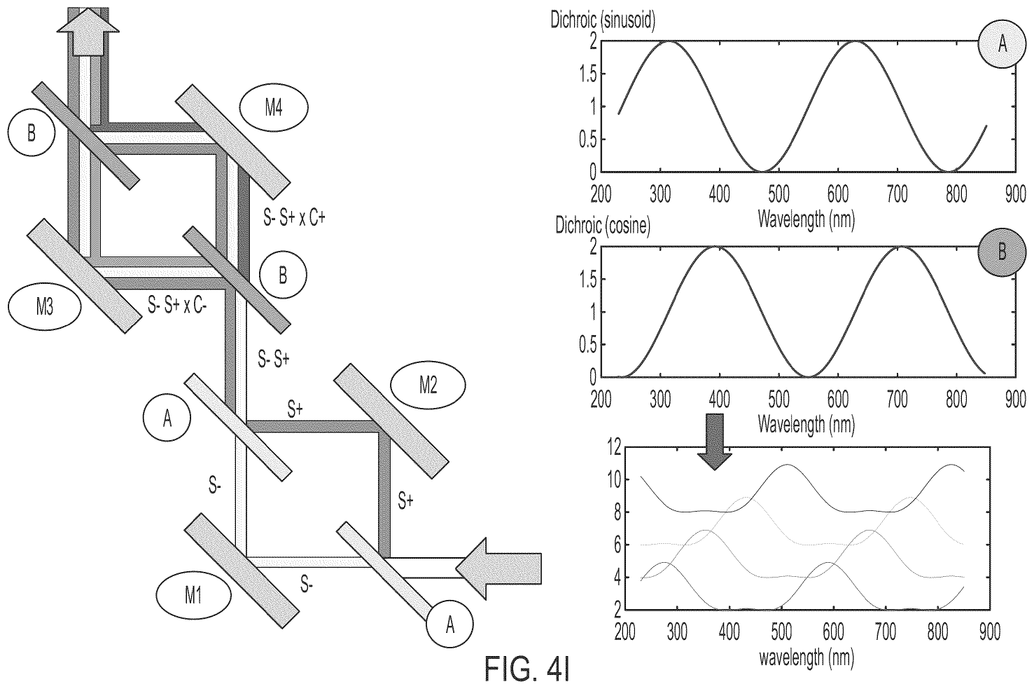

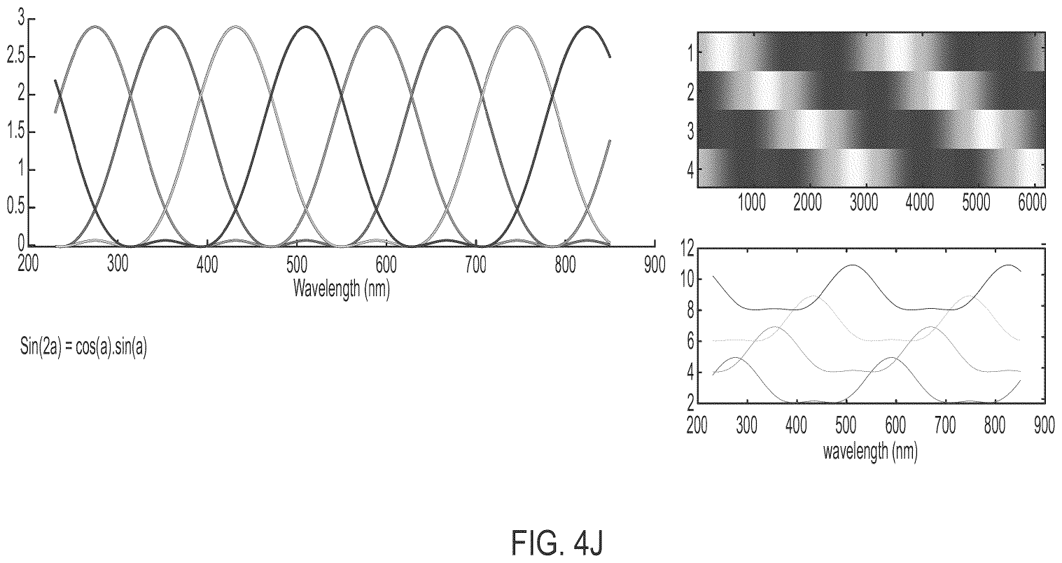

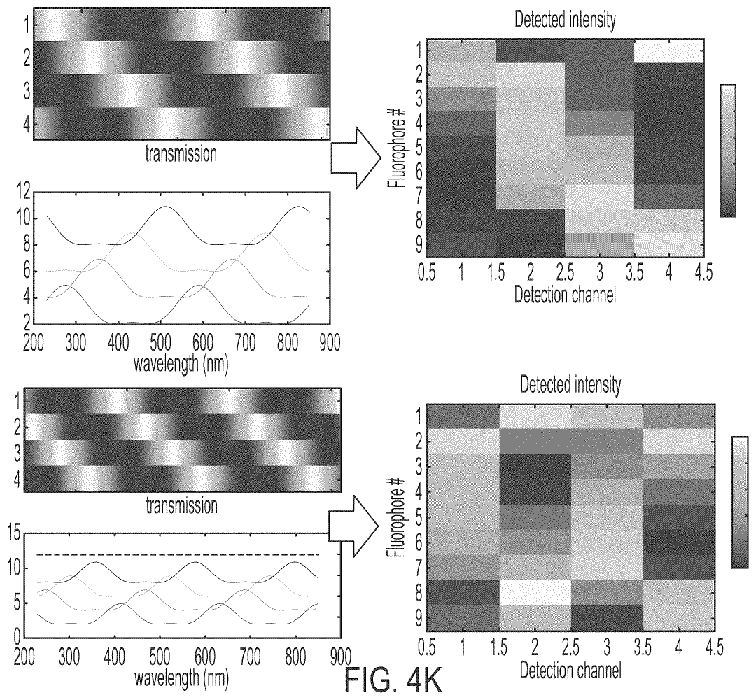

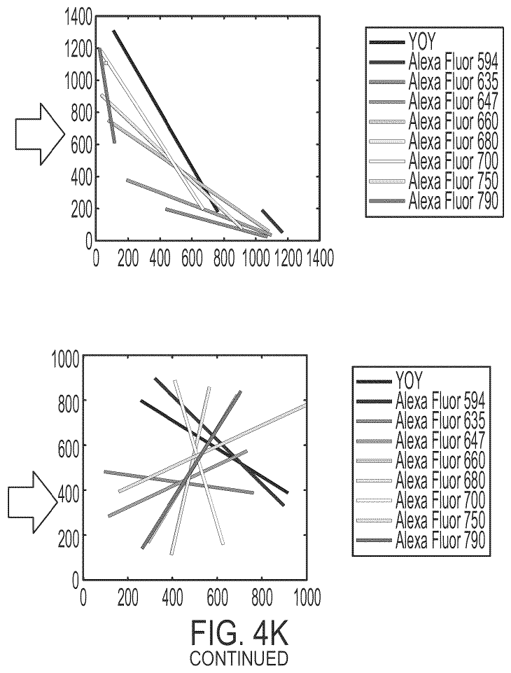

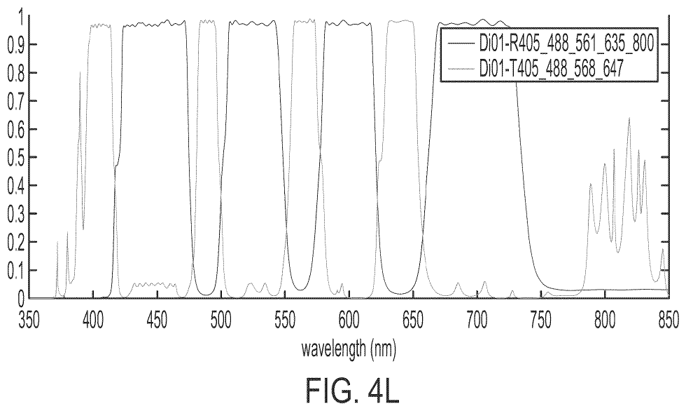

Turning now to FIG. 4A, a phasor-based spectral encoding approach was recently demonstrated which uses the two spectral filters with the cosine-shaped and sine-shaped wavelength transmission patterns depicted in FIG. 4A rather than specific pass bands. While excitation wavelengths need to be blocked, the signal in each pixel (for registered images acquired with the two different filters) will place the substance on a 2D phasor plot-enabling visualization and separation.

What is recognized here is that optionally, these two sine and cosine images can be collected together within two channels of an image splitter (e.g., using a suitable set of dichroics) to leverage this approach for rapid multiplexing. We note that there are similarities between this approach and the approaches described above in sections 2 and 3.

There is, however, a disadvantage of using a two component phasor since it discards light and irregularly samples the spectral range because cosine+sine by themselves gives non-uniform spectral sampling (in the shape of a sine wave). In contrast, four sinusoidal patterns added together are completely complementary (as depicted in FIG. 4B), and would capture all light emitted across the range, while providing richer four dimensions of phasor encoding. The patterns shown correspond to 1+cos(λ/50), 1−cos(λ/50), 1+sin(λ/50) and 1+sin(λ/50). Signals detected through each filter corresponds to the multiplication of the fluorophore emission spectra by the filter's sinusoid pattern, summed over all wavelengths.

FIG. 4C shows that, for a multitude of fluorescent agents (including closely spaced NIR fluors), we can simulate what we would measure through the four sinusoidal filters with passbands as shown in FIG. 4B to generate a four component spectral representation. Note that plotting these four values for each fluorophore as a line shows the uniqueness of their spectral fingerprint.

FIG. 4D shows that stacked notch or multi-notch filters are also required to block illumination wavelengths. Simulation results include these notches and assume simultaneous illumination with 488, 594, 660 and 780 nm lasers (which can have their power individually adjusted to make dynamic range as uniform as possible). Note that ‘basis set’ combinations of signals for pure fluorophores (for given filters and laser powers) are needed for unmixing to work. Ideally these would be measured directly, but can be simulated, can be sampled from acquired data or estimated using blind source separation techniques. Here, we purposefully chose a reduced set of laser excitation wavelengths to preserve spectral range for detection. Common wavelengths (488, 594, 660 and 780 nm were selected). Although results suggest good excitation of the full range of fluorophores, optimal lasers should be selected for the chosen set of fluorophores.

Turning now to FIG. 4E, after incorporating the transmission spectra of the notch filters, we can predict the signals detected in the four spectral phasor channels for each excitation laser wavelength. It is possible to acquire each of these sets of laser illuminations in turn, generating an excitation emission matrix rich in information as depicted in the four left panels of FIG. 4E. However, to acquire this data, each additional laser that must be switched on and off will proportionally scale to longer acquisition times. Alternatively, all four wavelengths can be activated simultaneously, in which case the results would be as depicted in the right panel of FIG. 4E, where the data is the sum of all of these contributions.

FIG. 4F shows the result of unmixing using non-negative least squares fitting on the data from the right panel of FIG. 4E, wherein each four-element spectral signature was tested for best fit to any of the 9×4 clement signatures. The result shows that the identity of each fluorophore can be unambiguously derived from just these four measurements, exceeding coding achieved with pure emission-band based analysis.

This method can hold when notch filters are applied to the emission spectra and when measurements are made with multiple lasers simultaneously illuminating the sample, giving multiplexed encoding in four spectral emission snapshots. Here we used lasers (and notches) at 488, 594, 660 and 780 nm to excite all of the fluorophores together. The approach can tolerate modest noise in the data.

This approach extends to permit unmixing of overlapping regions that represent linear combinations of different fluorophores, as shown in FIG. 4G. Here, a simulated structure is composed of overlapping rectangles modeled as each containing a different fluorophore (as listed in FIG. 4C). Adjacent fluorophores overlap with each other such that signal in this overlapped region is the sum of the emission spectrum of both fluorophores. The unmixing result demonstrates the system's ability to unmix fluorophore concentrations, even when overlapping, using only the four input images shown on the bottom row. FIG. 4H shows that the same result can be achieved with the addition of noise.

For practical implementation we consider how to generate all four spectral images from incoming data with high efficiency and with technical simplicity. Although we note that sinusoidal filters have been manufactured before, and that reasonably these can be dichroic filters, image splitting using such filters to obtain sinusoidal outputs is challenging. In contrast, the image splitter design in FIG. 4I incorporates sinusoidal and cosine spectral filters and provides efficient splitting of the light into four useful phasor components. This design can use one or more cameras (e.g., 2 or 4) per the configurations shown in FIGS. 8A and 8B depending on the need for denser sampling, larger FOVs/more speed.

Note that the components resulting from this image splitter design will not be 1+cos(λ/50), 1−cos(λ/50), 1+sin(λ/50) and 1+sin(λ/50), but will instead represent multiplicative pairs of these components as shown in FIG. 4J. We show that these slightly different spectral shapes themselves still average to a uniform distribution across wavelengths, and provide equivalently orthogonal information to classical sinusoidal or cosine patterns. This analysis shows that this approach can work with a diversity of different functions of modulating transmission with wavelength.

FIG. 4K shows that the wavelength-frequency of the cosine/sine filters for fluorescence sets can be adjusted to ensure uniqueness, for example by reducing the period of filters used in the image splitter since the effective frequency of the output is lower than the primary cosine pattern.

Filters with these sinusoidal (or similar) characteristics can (and have been) custom fabricated. They are relatively simple to design since generally filter design is difficult when sharp cut ons or cut offs are required, or certain wavelengths need to be strongly attenuated (which is not the case here). A simple, smoothly varying function (e.g., in the form of a dichroic which transmits and reflects the complementary wavelengths, e.g., like in FIG. 4L) can be used. Frequency of modulation does not necessarily need to be constant over the entire spectral range.

Similar off-the shelf filters can also be used to leverage this idea (linking to the ideas described above in sections 2 and 3), although they may not meet the requirement of both overlapping and summing to 1 to be optimally efficient at detecting all wavelengths in the range. This is best seen in FIG. 4L, in which the filters have reciprocity and thus efficient light collection but insufficient ‘phase’ between them to give the ability to fully separate the inputs in the unmixing result.

Note that adding additional spectral information by acquiring emission channels with subsets of lasers, or individual laser wavelengths would increase the dimensionality of the input data enabling further multiplexing, following the examples described above in sections λand 3.

### Section 5

### Labeling-Based Multiplexing

If we can encode 9 or more fluorophores (and their relative concentrations) with only 3 or 4 images, as described above, how can we further expand the information about the sample to be imaged? For imaging the cleared human brain, there is a desire to map a large number of different cell types. In transgenic animals there is more flexibility to selectively drive expression of fluorescent labels. However, for staining type imaging, we generally rely on immunohistochemistry. A cell's ‘type’ is then typically targeted using an antibody that is selective to some unique aspect of a particular type of cell. However, with this approach, we would need to assign one specific fluorophore color to one specific cell type. While this can make interpretation easier since cell identity is a binary yes/no read-out, the diversity of cells to be identified is limited to the number of fluorophores. While we can image many fluorophores, there is an upper limit due to the amount of spectral range available and the overlap of fluorescence emission spectra.

By considering labeling strategies, one can significantly increase the number of cell types that we can differentiate. These approaches can be used independently or in combination with any of the spectral multiplexing and unmixing strategies described above.

One approach is to target common features of multiple cells in combination. For example, one can look for expression of nitric oxide, which would be present in both endothelial cells in blood vessels and NOS neurons and label it with fluorophore (A). A second label targeting connexins (B) can label blood vessels and astrocytes but not NOS neurons. Thus, 3 cell types can be distinguished using only two independent labels, assuming that the presence of label mixtures can be properly evaluated e.g., using the matrix shown in table 5.

TABLE 5

| | nitric oxide | connexins |
|---|---|---|
| NOS neurons | yes | no |
| Blood vessels | yes | yes |
| Astroctes | no | yes |

This kind of overlapping labelling has been used in IHC and it is, in fact, challenging to devise labelling strategies that are selective for only a single type of cell. For the purposes of differentiating cell populations in large scale imaging though, this approach can enable significantly more multiplexing than selective labelling. Additional analysis (e.g., RT-PCR) can be used post-hoc to identify the exact cell types with each combination of labels.

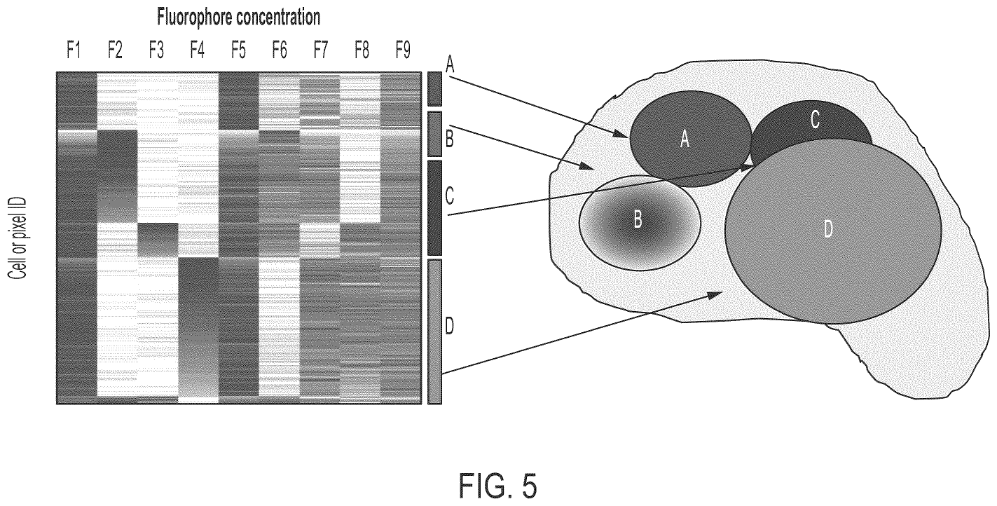

This approach can further permit bulk analysis of the presence of different cell types and their spatial distribution without spatially-based image segmentation or tracing. This can be achieved by analyzing all detected pixels and clustering them into groups based on their relative labeling levels of the range of fluorophores present, as depicted in FIG. 5. The spatial location and density of pixels with each combination can be readily mapped revealing cell type distributions over a large dynamic range, with relatively few overlapping labels. This approach can be especially effective if expression levels or binding labels provide a quantitative level of the amount of a given target in a specific cell or structure.

Additionally, one can apply similar unmixing, non-negative factorization or blind source separation analysis methods to this kind of data, wherein instead of solving for concentration of fluorophore, one solves for the spectral identity of the cell type. Priors of expected cell type spectral profiles (either in raw fluorescence or via expression patterns and labels) can be used to constrain the analysis or search for specific combinations.

Section 5.1—Additional Multiplex labeling IHC

In similar coding strategies one can make primary antibodies with multiple targets. Here, by having overlapping sets of targets, the code for cell type identification can be expanded. Assume, for example, Rabbit antibody targets ligands A and B, Donkey targets B and C, Goat targets C and D. If each were then matched to 3 colored secondaries, you would be able to identify four types of cells A, B, C, D from 3 combinations (R, RG, DG, and G)

In a similar strategy, one can label secondary antibodies with more than one fluorophore. This can be a simpler strategy that avoids the complication of targeting binding to specific ligands. Here, assuming unique extraction of each fluorophore, either via conventional methods or by spectral multiplexing, that can identify linear combinations of fluorophore from non-overlapping cells, we can again encode more specific identities with fewer discrete spectral ‘channels’. While pairing neighboring fluorophores might be similar to just using an intermediate fluorophore (e.g., a yellow fluor between a green and red), one can space out pairing across the spectrum making combinations more unique and easier to pick out. Another advantage here is the ability to use fewer, well characterized and stable fluors and a reduced number of excitation wavelengths.

As an example: Donkey—AF488, Rabbit—AF488 and AF660, Goat—AF 660, Kangaroo—AF 594, Sheep—AF 594 and AF 488, Chicken—AF 660 and AF 594. Here, 5 types of secondary can be identified by collecting only 3 fluorescent channels.

In addition, if there is some expected redundancy because certain regions of the brain have a cell type known to occur only in that location, one can use the same color label twice and use location or other features such as cell morphology to discern its identity.

### Section 5.2—Spatio-Spectral-Dynamic Unmixing

With dynamic unmixing, a sequence of images of a sample can capture dynamic processes such as the propagation and uptake of a dye injected into a mouse, or flashing of GCaMP activity in neurons in a brain sample.

The ability of most of our imaging systems to acquire data very rapidly, often over 3D volumes, permits application of analysis techniques which seek to represent the image series in terms of spatial and temporal components. The identity of an organ in a mouse, or a neuron in a brain can be defined based on the way it changes over time, and if data is searched (e.g., using non-negative least squares fitting) to find all pixels with this time-course, functionally similar structures can be identified.

There are parallels between the dynamic unmixing and spectral unmixing approaches detailed above. We note that if each image in a time-series has a plurality of spectral information which can be used to unmix and segment information, the additional time-dimension (in systems that are alive, or can be perturbed in some way such as by application of a chemical, bleaching, heating, etc.) will provide an additional dimension of identity to pixels within the image. These dimensions of information can be combined for even wider ranging multiplexing and unmixing.

### Section 6

### Image Splitter Divergence

As explained above in connection with FIG. 1, a relay lens telescope 32, 36 can be positioned after O3 to project a conjugate plane of the back focal plane of O3 into the image splitter 42. This section describes a variety of approaches for reducing the divergence of light in the light path after O3 by relaying the light into the image splitter, preserving greater field of view at the camera for multicolor imaging. In the images in this section, light travels from left to right.

Image splitters in traditional SCAPE systems have divergent rays coming into the image splitter (out of the back of O3) and these rays get clipped passing through the image splitter and into the tube lens in front of the camera. The rays effectively diverge from the point of the back focal plane (BFP) of O3 which is positioned quite deeply inside O3.

This section describes a design for a telescope to relay that image plane to a position that permits the light going through the image splitter to be more tightly constrained and thus clipped less, maximizing the field of view reaching the camera. This is especially important for dual color imaging where the two split color images must both make it into the tube lens in front of the camera without clipping.

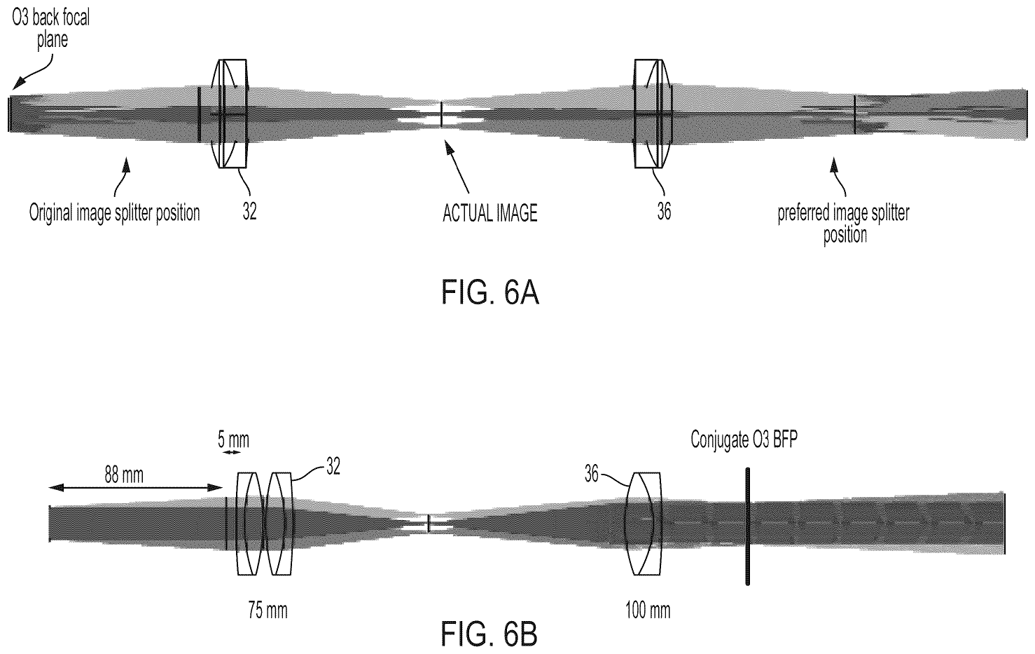

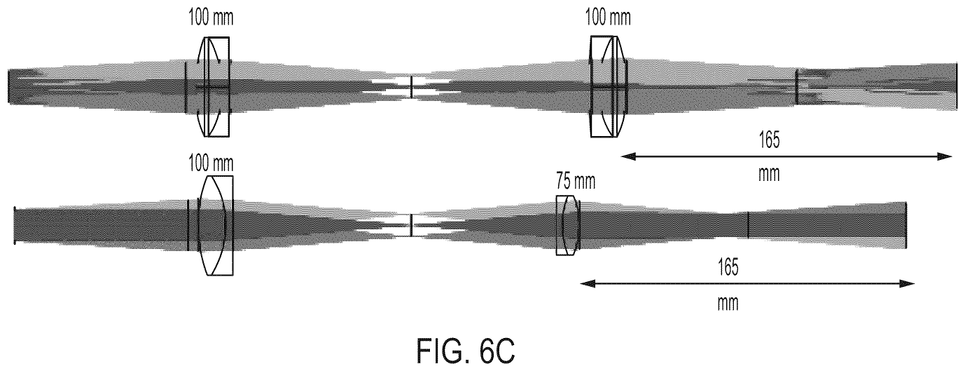

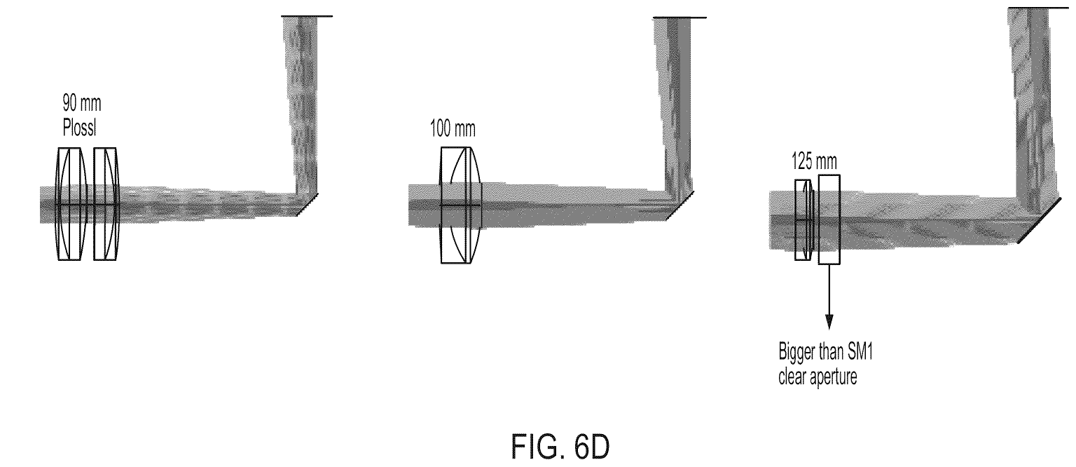

FIG. 6A shows that the position of the image splitter has been moved from the traditional location immediately following the back focal plane of O3 to the output of a relay lens telescope that is made from two lens groups 32, 36. The first lens 32 collimates the light to avoid light loss and forms an actual image between the first lens 32 and the second lens 36. This is advantageous because an aperture can be added between the first and second lenses 32, 36 to clean up the image and prevent bleeding. The configuration depicted in FIG. 6A has a converging beam to the right of the first lens 32 followed by a diverging beam beyond the actual image.

FIG. 6B shows a set of workable parameters for the relay lens telescope made using two lens groups 32, 36. For the first lens 32, the focal length should be greater than 88 mm because it is desirable to have the conjugate O3 Back Focal Plane (BFP) as far away from the second lens as possible to prolong converging light path. 100 mm is therefore a suitable focal length for use as the first line 32.

FIG. 6C depicts what the output beam diameter will be at a distance of 165 mm beyond the second lens 36 for two different combinations of first and second lenses 32, 36. If we assume an input beam diameter of 15 mm and a 1 mm field of view and the focal length of both the first and second lenses 32, 36 is 100 mm (as depicted in the upper panel of FIG. 6C), the output beam diameter at a distance of 165 mm will be 22.6 mm. But if the second lens 36 is changed to a 75 mm focal length (as depicted in the lower panel), the output beam diameter will be 23.4 mm.

FIG. 6D shows what the field of view will be for three different second lenses 36, assuming that the first lens in the relay lens telescope is 100 mm. If we reduce the input beam diameter to 10 mm and have an output beam diameter of 22.6 mm, using a 90 mm Plossl lens as the second lens 36 will result in a 2.22° field of view (which translates to 700 μm); using a 100 mm lens as the second lens 36 will provide a 2.54° FOV (which translates to 800 μm); and using a 125 mm lens as the second lens 36 will provide a 2.68° FOV (which translates to 850 μm). Among these choices, the 100 mm/100 mm pair is the optimal choice. In a single channel system, this combination will provide a 15 mm full aperture and a 1 mm FOV. In a dual channel system that is limited to a 10 mm aperture, the system can achieve an 800 μm FOV without cropping. And in a dual channel system that is limited to a 7 mm aperture, the system can achieve a 1 mm FOV without cropping.

### Section 7

### Vertical Image Splitting

This section is useful when the number of pixels on the camera for horizontal image splitting is limited or where signal to noise needs to be improved over sequential imaging in multi-spectral imaging.

Referring now to FIG. 7A, the horizontal image splitter configuration that has traditionally been used in SCAPE systems has the following four attributes: (1) Aligns images with center of camera chip 140 for fastest read-out (from center of chip). (2) Read out is fastest with fewer rows, and thus you get both colors of image at the same time without sacrificing imaging speed. (3) The number of pixels in each image along Y is limited to the total number of pixel columns of the camera divided by λ. (4) For high resolution imaging (e.g. 0.5 microns per pixel over >350 microns) the number of pixels on a standard sCMOS camera (2048×2048) can be sufficient, but some higher speed cameras have fewer pixels (e.g., the HICAM fluo with 1280×1024 pixels (cols×rows)).

For use of a camera with fewer pixels/different read-out characteristics (e.g., intensified camera such as the HICAM fluo) the image splitter can place the two spectrally separated images vertically above and below each-other (along z′—rows) as depicted in FIG. 7B, rather than side by side (along y—columns), as depicted in FIG. 7A. This trades off imaging readout speed for field of view, but also provides an improvement in integration time per pixel.

Although the FIG. 7B vertical configuration uses more rows of the camera, it permits a wider field of view without sacrificing sampling densities. Although this means that the maximum achievable frame rate of the camera is lower (approx. half), we note that this also means a 2× increase in the integration time per pixel for both images. Thus, one should get similar signal to noise in a single image in this FIG. 7B configuration compared to averaging two of the images in the original FIG. 7A configuration. So in situations where this trade-off needs to be made to ensure sampling density along Y, at the expense of either volumetric imaging speed, or field of view/sampling density across the scan direction in X, there is a signal to noise advantage. Where the alternative might be to collect the two spectral images sequentially, this approach will detect twice as much light at the same speed, will give truly simultaneous imaging, and is facilitated by SCAPE's typical use of less than all of the rows on the camera (given the Y-Z orientation of the detected image across cols-rows).

This vertical FIG. 7B configuration also highlights the benefit of employing asymmetric magnification in the system—which we have found to work by inserting a cylindrical lens telescope in the third arm of the system (between O3 and the camera), as shown in FIG. 7C. This FIG. 7C approach can be used to compress Z, lowering sample density in depth but decreasing the number of rows required, thus increasing volumetric imaging speed while maintaining the X, Y and Z field of view and the X and Y sample densities. This FIG. 7C approach introduces asymmetric magnification within the third arm of the system to be able to fully adjust the X, Y and Z sample densities.

### Section 8

### Multi-Camera/Four-Way Image Splitting

FIGS. 8A and 8B show designs combining different filters to enable four-way splitting of emission images onto two cameras or one camera, respectively.

More specifically, FIG. 8A depicts a configuration that uses two cameras with four emission channels and one image splitter—and mixes two different dichroic filters. The first dichroic filter A (which can be, e.g., part number FF526-Di01) transmits the longer wavelengths (red and yellow) and reflects the shorter wavelengths (green and blue); and the second dichroic filter B (which can be, e.g., part number FF493/574-Di01) transmits red and green wavelengths and reflects blue and yellow wavelengths. In this embodiment, mirror (1) can be used to move the red and yellow channels to the top/left of the respective camera; and mirror (2) can be used to move the blue and green channels to the top/left of the respective camera.

FIG. 8B depicts a single-camera configuration that uses four-way image splitting using three different dichroic filters. The first dichroic filter A transmits the longer wavelengths (red and yellow) and reflects the shorter wavelengths (green and blue); the second dichroic filter B transmits red and green wavelengths and reflects blue and yellow wavelengths; and the third dichroic filter C transmits yellow and green wavelengths and reflects red and blue wavelengths. In this embodiment, mirror (1) can be used to move the red and yellow channels to the top of the camera; mirror (2) can be used to move the blue and green channels to the bottom of the camera; mirror (3) can be used to move the yellow and green channels to the left of the camera; and mirror (4) can be used to move the blue and red channels to the right of the camera.

### Section 9

### Image Splitter Designs for Spectral and Multi-Scale Multiplexing.

Calculations of trade-offs between different configurations for very high speed imaging of large samples have produced the following realizations:

An important element of large scale mapping is to detect more than one ‘type’ of structure within the volume, whether different labels for in-situ sequencing or different fluorescent protein or antibody stains. The standard approach in biology is to attempt to label a single structure with a single color fluorophore (or e.g., in animals, to selectively express a fluorescent protein). If multiple fluorophores are present, it is typical to image each in turn, exciting with different lasers and/or mechanically changing narrow band emission filters in front of the detector to isolate the signal from each fluorophore.

In order to scale imaging to capture many different types of structures in large volumes at high speed with high signal to noise, this classical approach faces two major limits: (1) Existing fluorophores have wide spectral excitation and emission ranges and overlap significantly across the visible wavelength range. Overlapping more than 10 standard fluorophores in this range is likely to be intangible and it would be impossible to precisely detect only one fluorophore in a wavelength band. (2) Imaging so many different (N) fluorophores in turn would increase total imaging time by at least a factor of N (assuming no moving parts) while data storage would also increase by N.

The inventors have recognized the following solutions to this problem. First, we can screen for fluorophores with ideal spectral properties (broad excitation and narrow emission ranges). Fluorophores with these properties are often used for flow cell cytometry. Long-wavelength fluorophores (up to or above 780 nm excitation) can be leveraged, extending the wavelength range over which to multiplex while importantly avoiding strong blue-red tissue autofluorescence found in tissues such as the human brain.

Second, we employ customized image splitters which permit multiple spectrally-resolved images to be projected side by side onto a single camera chip. Careful filter design can permit these images to be acquired with multiple lasers on simultaneously, preventing the need to cycle through different lasers and optimizing speed.

Image splitters are advantageous here for a number of reasons. Depending on the chosen per-image field of view and sample densities, it could be unlikely that each image will fill the full chip of available high-speed cameras. Putting N channels side by side along columns of the camera chip adds no penalty to imaging speeds. Adding N channels over rows decreases frame rates by N, but increases integration time by N (and thus improves SNR).

In contrast, sequential imaging with multiple lasers reduces imaging speed by N without improving integration time, while multiple individual cameras add cost and add mechanical and data interface challenges, while wasting available columns and imaging capacity.

Based on modeling typical system parameters with currently available cameras, one suitable approach is to fill the camera chip with at least four tiled spectral channels, with the ability to extend to two or more cameras providing a total of 8+spectral channels. Through optimization of filter designs and careful choice of fluorophores and lasers, all 8 of these spectrally-resolved channels can be acquired efficiently and simultaneously.

### Section 9.1—Using N Channels Does Not Necessarily Limit Us to N Fluorophores

When using spectrally close emission bands it is most light efficient to capture the broadest possible emission bands. But this will naturally cause some spectral cross-talk between channels. Fortunately, this cross-talk can be addressed using well-characterized spectral unmixing strategies that use the spectral signature of each pixel (across all channels) to infer the concentration of fluorophore in that pixel. While adding a computational step, this unmixing strategy can improve noise tolerance since it incorporates prior knowledge of the spectrum of each fluor present. With this approach, it is mathematically possible to solve for 16 fluorophores from acquisition of two sets of 8 (fixed) emission bands for data collected with two sequential sets of laser illumination (costing a 2× speed reduction).

Moreover, many increasingly sophisticated strategies can (in constrained systems) permit extraction of more than 8 fluorophores from 8 spectral measurements including phasor encoding for which we have a novel, light efficient image splitter design. Simulations of ideal conditions predict the ability to resolve 9 fluorophores from four spectral channels. While AI-based approaches can improve performance, constraints include the level of physical and spectral overlap between fluorophores, which is a function of cell type, labeling strategy and 3D imaging system resolution.

Extending from the phasor-based image splitter design above, we recognize some redundancy regarding our collection of four channels corresponding to A=cos(lamba), B=cos(lambda+pi), C=sin(lambda) and D=sin(lambda+pi). It is possible to extract the same information (assuming perfect filters) from just 3 channels corresponding to sin(lambda), cosine (lambda) and a ‘white light’ scan collecting all wavelengths (since 1−sin(lambda)=1+sin(lambda+pi)). However, there can be advantages to our four element approach namely: (1) Perfect filters which exactly match sin and cosine may not be available. (2) An image splitter design that seeks to capture only ‘full spectrum’, cosine and sine could not be 100% efficient. (3) Our design collecting all four combinations provides the equivalent of being able to calculate the ‘full spectrum’ component by summing all four channels. Feasibly this mathematical operation can be done during imaging so that only the equivalent of 3 channels (sine, cosine and the sum of all four channels) is saved to disk. This can have some signal to noise benefits over just 3 measurements while also being close to 100% light efficient. (4) Similarly having four complementary measurements with some redundancy can permit error-checking between channels, for example: sum (ABCD)/2−A=B.

We also recognize that mathematically (without constraints) it is only theoretically possible to extract 3 fluorophores unambiguously from the 3 phasor measurements and that extracting more depends on the properties of the data. Some spatial overlap of multiple fluorophores can be tolerated when unmixing phasor data for more than 3 fluorophores, but additional constraints are required to do so unambiguously from complex, mixed data.

However, we note that phasor based acquisition is equivalent to collecting the amplitude of the fluorescence emission at the phasor frequency given by the filter, such as the measurement corresponds to the real and imaginary components of the Fourier transform of the emission spectrum detected. It is thus possible to acquire additional complementary information using a second set of phasor filters with a different modulation frequency across wavelength, filling in the Fourier space description of the fluorescence detected. Such filters can be combined within current (and extended) spectral image splitter designs to generate efficient multiplicative mixtures of multi-frequency encoded signals which would add dimensionality to the inverse problem (permitting 5 fluorophores (given by ‘full spectrum’, sin (freq1), sin (freq2) cosine (freq1) and cosine (freq2)) to be unambiguously resolved) and more information to assist in solving the ill posed inverse problem of unmixing larger numbers of fluorophores.

### Section 9.2—Combinatorial Classification

Another multiplexing strategy to map and identify a plurality of structures is combinatorial coding of labeling. In many systems it is possible to encode structures with different combinations of labels, and these combinations can be mixed with different levels. In ‘brainbow’ mice this is done by expressing different numbers of and combinations of 3 spectrally distinct fluorophores producing a wide range of different perceptible colors (based on combinations) in each cell of the brain permitting segmentation and tracking. Recent work on monoclonal antibodies (mAbs) suggests that labeling in immunohistochemistry (IHC) with mAbs can provide a more quantitative read-out of protein levels compared to prior versions of IHC. This means that such combinatorial strategies can now also be applied more broadly in samples where IHC can be performed. This approach permits significant stratification of cell diversity, especially if one utilizes markers with broad dynamic patterns (e.g., transcription factor networks) with broad affinities rather than cardinal markers that seek to target only a single cell type.

Assuming only binary (there/not there) classification of markers, we could classify λ56 (2\hat{ }8) unique antibody signatures using 8 spectral channels. A more conservative strategy is to use a subset of spectral channels for cell-specific cardinal markers and then simultaneously acquire transcription factor markers in remaining channels. If 5 channels are used for cardinal markers and 3 for more diverse markers, for binary coding of levels one could thus classify 8 combinatorial antibody signatures (2\hat{ }3), overlaying 5 cardinal markers. If we could assume mAb linearity to classify 3 or 4 levels of expression (none, low, medium, high) we could encode 3\hat{ }3=λ7 or 4\hat{ }3=64 signatures in the 3 diverse marker channels. Simultaneously acquired cardinal markers could be used to validate classification results.

### Section 9.3—Multi-Scale Simultaneous Imaging

Given the enormous scale of imaging data collected in large samples one must consider the practical limitations on the data that can be collected, stored and analyzed. The most important consideration is that the data produced must have sufficient signal to noise, resolution and cell type specificity to permit accurate extraction of parameters that will provide value to the study at hand. The table in FIG. 9A shows a range of possible imaging configurations that we have derived for imaging a large ˜spherical sample such as a human brain with maximum dimension 140×170×93 mm. This table depicts many tradeoffs, but most striking is the limitation imposed by higher resolution imaging of such a large sample, for example the line marked with the arrow which will produce an enormous 15.7 PB of data for uniform sampling of just four spectral channels at 0.6×0.6×0.78 micron sample densities.

What we have recognized is that we do not necessarily need to acquire all channels of this imaging data at the same spatial sampling densities. Our ability to make image splitters means that we could split images up onto a camera to collect many spectral channels if they can be lower resolution (e.g., um/pixel mapping of these images can be large). For the 3200×3200 kinetix camera chip, it is in principle possible to collect 16 spectral channels at 2.5 ×2.5 micron resolution (note that technologies other than formal image splitters such as snapshot imaging spectrometer could also be employed here to capture equivalent spectrally resolved information). However, in some cases (such as tracking fine processes or segmenting the individual nuclei of every cell present in the sample) high resolution for a single color channel (or a mixture of several channels) can be essential. What we have recognized is our system's ability to combine imaging at multiple resolutions within the single acquisition workflow. This is particularly suitable for SCAPE and related light sheet systems since magnification is typically adjusted by a tube lens in front of the camera rather than by changing the objective at the sample (as is common in standard microscopes).

In the simplest case, one could use two cameras separated by a dichroic or beam splitter and use a different tube lens for each, as depicted in FIG. 9B. Camera acquisition could be synchronized through triggering (or not) and both data streams could be collected as the sample was scanned (or galvo scanning was used). However, the power of this method comes from the recognition that one could then use the extra space on the lower magnification camera to split color channels, while still collecting the same camera area on both cameras at the same speed, as shown in FIG. 9C. Images can thus be exactly registered in space, and high resolution structural information can be overlaid (or co-analyzed) with lower resolution spectral information. This can be valuable, for example, for color labelling specifically targeting sparse cell types where there is unlikely to be the need to segment the color image, but that the color pattern around a nucleus segmented in the higher resolution image could be used to determine that cell's type. One can acquire the cameras at different imaging rates to permit over-sampling of images on the higher resolution image (along x) while integrating for twice as long (for example) for the camera capturing multiple color channels to enhance sensitivity to labels with less brightness. One can use different cameras at the same time in this configuration to match the camera's properties to the requirements of different labels/structures and magnifications (e.g., an intensified camera with lower pixel counts vs. a less sensitive camera with higher pixel counts). One can also make image splitters incorporating multi-scale components wherein a subset of the split light is magnified to permit single camera based multi-scale imaging, as depicted in FIG. 9D.

We additionally recognize that snapshot spectral imaging concepts proposed by Tkaczyk and others could be leveraged to generate lower resolution spectrally multiplexed images in the context of SCAPE and HOLIS, and that this embodiment could incorporate the fiber bundle based or other ZWD approaches described in section 12 below.

### Section 10

### Image Registration with Spectral Priors

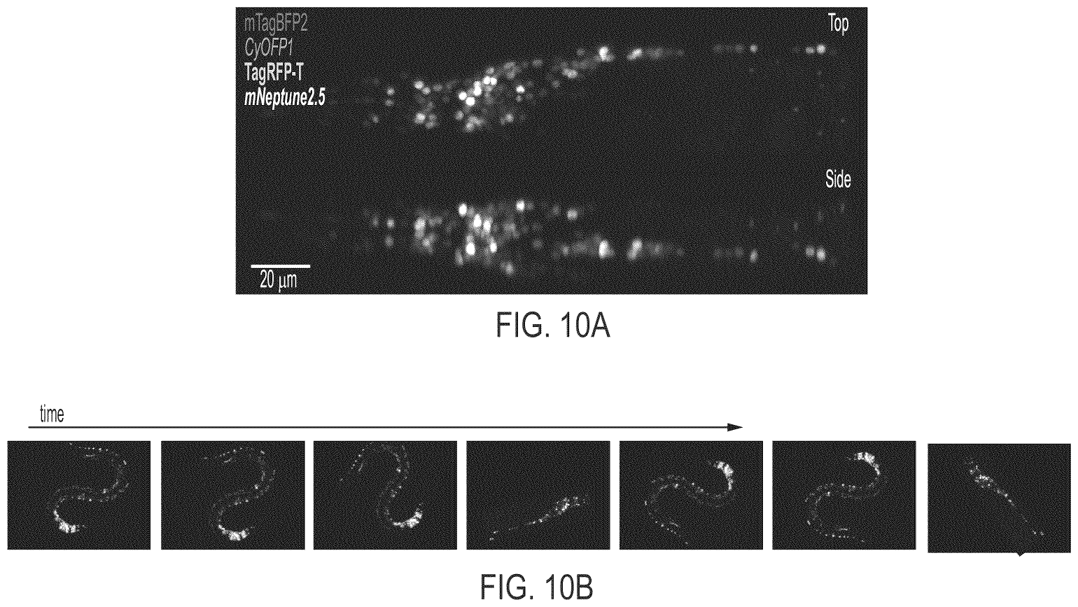

Referring now to FIGS. 10A and 10B, this section describes the use of spectral data encoding cell identity as snapshots in dynamic data to provide priors and constraints for cell tracking algorithms. More specifically, FIG. 10A depicts using spectral data for image registration. In FIG. 10A, each cell color combination specifies its identity. But we also want to capture fast 3D images of the sample moving, detecting calcium-sensitive GCaMP signals and pan-neuronal RFP to analyze the dynamics of neuronal activity during behavior. After high speed imaging we need to track all cells to extract this calcium activity as a function of movement/behavior.

Most spatiotemporal tracking methods identify features in each image, and then try to determine which object in the prior image corresponds to that same object in the next image. While this analysis approach can incorporate information, for example, on the trajectory of the object (or objects), mis-classification of an object from frame to frame is common and can lead to misassignment of the tracked cell.

Parallel acquisition of the spectral identity of every cell greatly simplifies the tracking process, because each cell has a unique identity which can thus be unambiguously assigned to each image over time. Thus acquiring high speed spectrally multiplexed information not only permits analysis of the activity of specific cells of known identity, it can greatly simplify the process of tracking each cell over time and space, permitting extraction of movements in 3D (behavior) and precise extraction of dynamic changes in GCaMP from each cell to extract its calcium activity patterns.

Note, however, that the speed needed to image a moving sample can be very high, while some fluorophores may be bleached through repeated imaging. It can therefore be advantageous to image a subset of fluorophores at very high speed (e.g., GCaMP and Tag RFP). By interleaving fast 3D imaging of GCaMP and RFP with bursts of spectral data acquisition, we can generate fully spectral ‘key frames’ of the object with each cell's identity resolved.

We recognize that these key frames permit access to the cells' identity for a range of time points as the animal is moving. However, we note that one can also incorporate these key frames into the tracking algorithm as a prior/constraint.

FIG. 10B depicts this tracking with spectral key-frames. We recognize that the animal is unlikely to change its shape so dramatically that adjacent cells will switch places. Its movements are also relatively smooth. One can thus assume that the path of a cell during intermediate frames (without multispectral information) will lay along an approximate trajectory between the key frames. This cell ID prior could be implemented analytically as a constraint on an iterative algorithm, or incorporated as training into an artificial intelligence based tracking algorithm.

Connecting to the prior framework describing spectral data acquisition and spectral unmixing above, we note that these strategies can also be incorporated into this analysis framework: Although data is acquired in spectral space, it can be converted to ‘fluorophore concentration’ using the spectral unmixing methods demonstrated. However, cell ID is not just encoded by each fluorophore, it is encoded by different relative concentrations of each fluorophore in each cell. This adds another dimension to the analysis, wherein spectral analysis can incorporate information about these expected relative concentrations as each cell's spectral fingerprint and solve directly for cell ID rather than the concentration of the fluorophore in each cell.

Movements of the sample might occur during spectral data acquisition (since 3 sequential laser illuminations are needed-either interlaced of over 3 sequential volumes). However, the trajectory of the movement can be incorporated into the calculation of the spectral identity of each cell and solved together.

### Section 11

### Spatiospectral Multiplexing

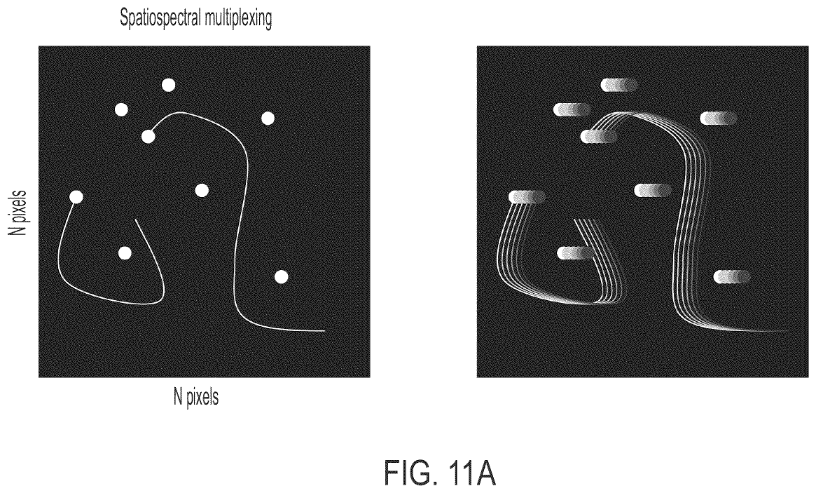

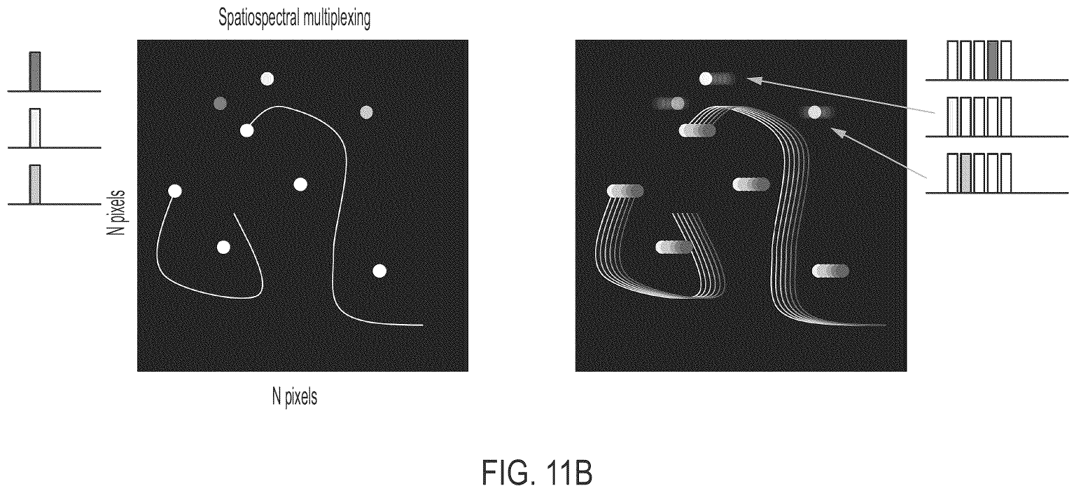

FIGS. 11A and 11B depict incorporating a diffractive element into the system to generate spatially dependent but overlapping spectral encoding in the detected image for ultrafast multispectral imaging over potentially even more dimensions than in the examples above.

We recognize that a conventional dual-channel image splitter generates two wholly separate spectral images (e.g., 2×N×N pixels). However, if spectral dispersion is introduced into the system, it will generate an image with spectrally resolved but overlapping features. Since the spectral/spatial transform is known, information can be recovered computationally-encoding M spectral bands in only N×(M+N) pixels.

A second image splitter channel records all fluorescence as a ‘white’ prior of the true physical shape of the sample's structures. Unmixing can use ‘white’ image information as a prior, with spectral dispersion representing the convolution of the white image with the spectral dispersion of the system. This approach has been demonstrated before for sparse samples in conventional/super-resolution microscopy but could be combined with SCAPE for ultra fast high content imaging of spectrally diverse samples.

### Section 12

### Meso-SCAPE

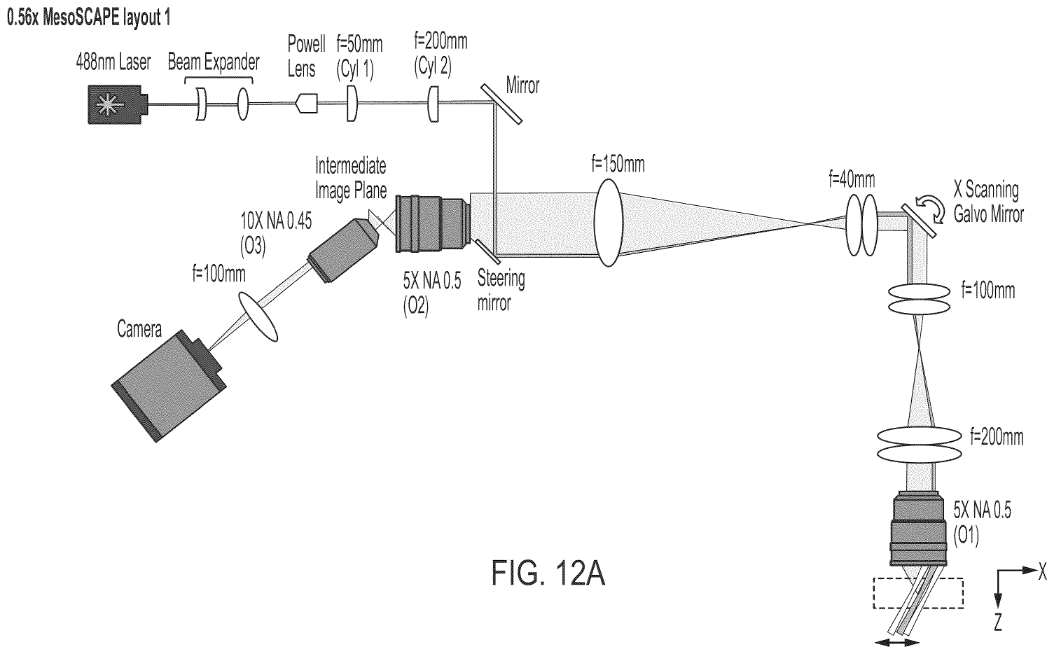

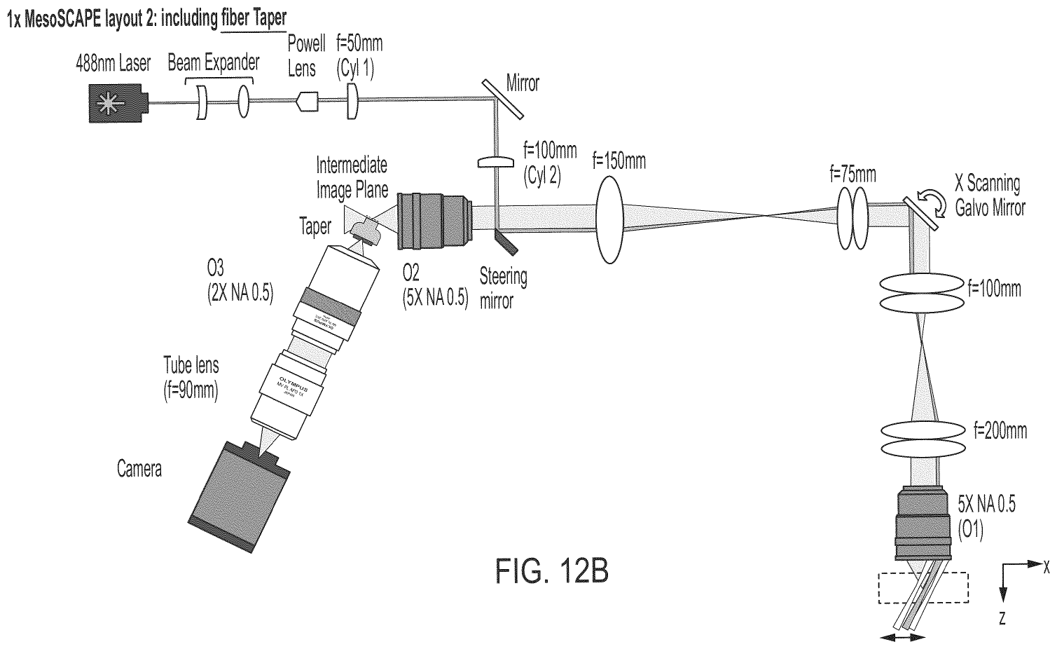

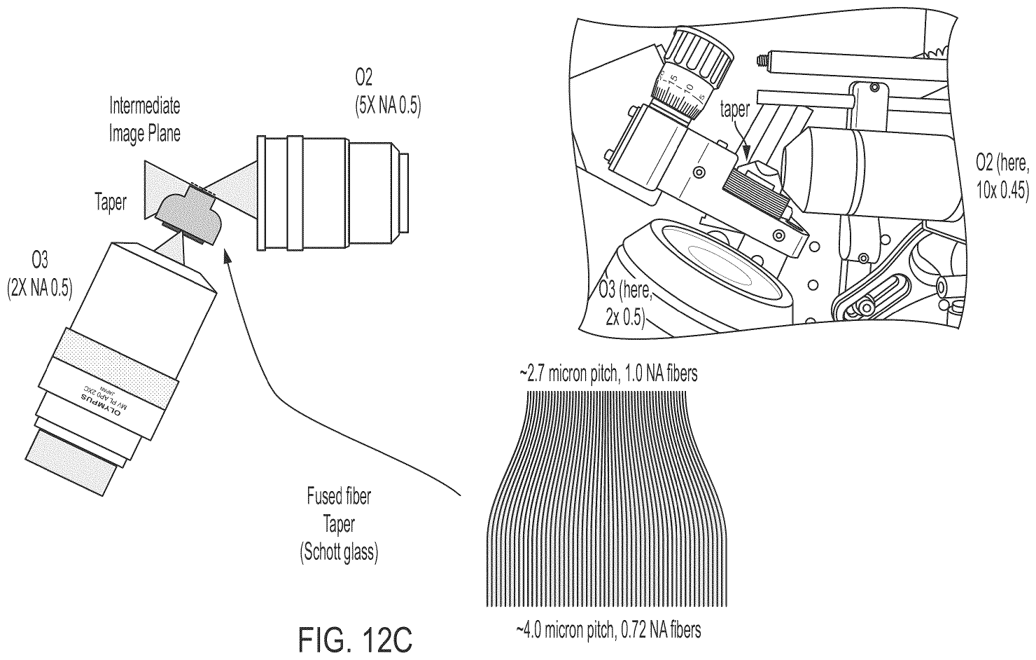

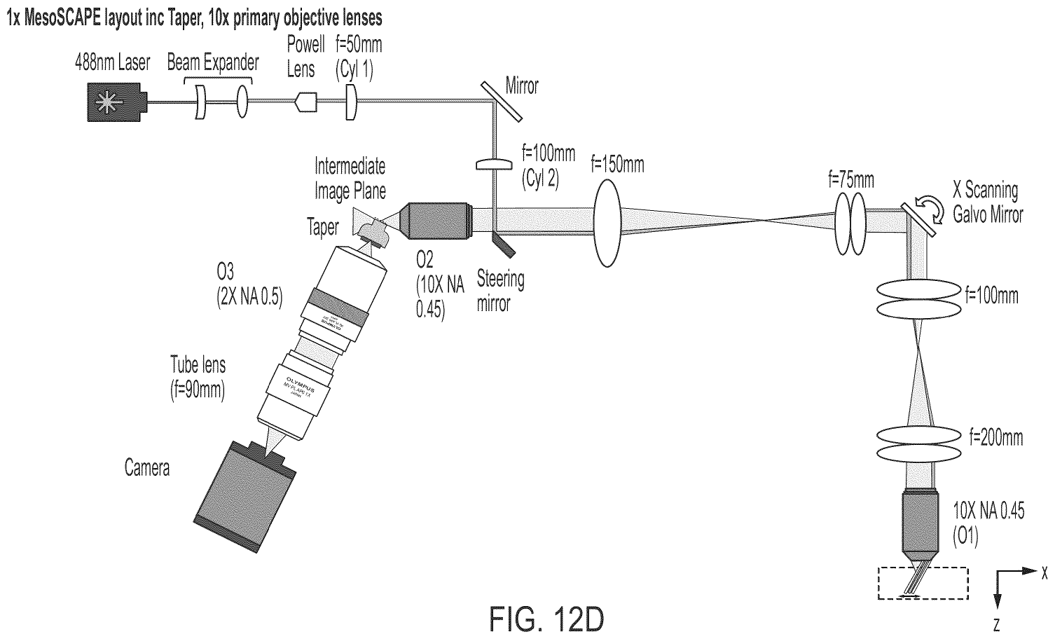

FIGS. 12A-D depict embodiments referred to herein as “Meso-SCAPE.” Meso-SCAPE provides 3D, high-speed imaging over large fields of view (e.g., up to 10 mm×10 mm in x-y). Applications can include imaging living whole samples such as entire zebrafish larvae, transgenic hydra, or large areas of living mouse cortex, brain slices, engineered tissues and large cleared and expanded tissues.

FIG. 12A depicts a first configuration (Layout 1). It uses two 5×0.5 NA Nikon lenses in a 0.5× magnification configuration. Note that this configuration deviates from the traditional ‘perfect imaging’ condition by decreasing the magnification between the sample and the intermediate oblique image plane (between O2 and O3) to increase collection angle (in order to be able to collect more light). In this embodiment, the scan field was 4.4×3.3×0.4mm3, and the resolution was 8 μm (x), 6 μm (y), 20 μm (z). It is important to get higher NA. The issue here was that larger field of view O1 objectives have low magnification and low NA; and if mapped to O2 with a magnification of 1, there would be zero free-space collection angle available. The FIG. 12A embodiment was able to collect nice images, but suffered from significant light loss owing to the mismatched pupil size of the non 1× telescopes.

The FIG. 12B embodiment provides an improvement with respect to the FIG. 12A embodiment. This embodiment relies on a tapered fiber bundle as a way to relay the intermediate image to the camera. Since this system doesn't require sub-micron resolution, the front (narrow) face of the taper was placed exactly at the oblique intermediate image plane and relayed light to a larger face which was then imaged to the camera. The high NA (1.0) fibers were able to capture more light than the free-space geometry, while the shape of the taper causes light coming out of its wider end to have a lower NA (e.g. 0.72), permitting additional improvements in collection efficiency with a lower NA (lower magnification) O3. With 0.5× magnification described above in connection with FIG. 12A. The system was converted to 1× magnification and was still able to image, with significantly higher throughput than the FIG. 12A embodiment. The FIG. 12B embodiment provided a scan field of 4.8×4.1×0.6mm3, and a resolution of 7 μm (x), 12 μm (y), 20 μm (z). The inventors found that lower NA (e.g., aperturing the O2 back pupil to 0.35 NA instead of 0.5 NA) resulted in a less aberrated PSF.

The inventors recognized that light entering the taper fibers at a steep angle was not being relayed and focused well in the O3 imaging arm. The inventors also noted concerns over the angles of the light entering the camera as a potential place for light loss to occur. Lens designs to reduce these angles or to get cameras with wider acceptance angles were considered. (FIG. 12B-D).

FIG. 12C is a detail that depicts how the image gets relayed and magnified by the fused optical fibers that make up the taper. The acceptance angle of fibers at its small face is greater than the free-space acceptance angle of an objective. Notably and advantageously, the 1.0 NA of the front fibers at the focal plane matches the ‘zero working distance’ approach to single objective light sheet microscopy. This means that, in principle, the full angle of light coming from O2 in air can be captured by the fiber bundle.

FIG. 12D depicts a further meso-SCAPE layout. This layout includes the fused fiber taper with a 10× primary objective lens. Table 6 below depicts three different O3 lens combination for the FIG. 12D embodiment.

TABLE 6

| O3 | Camera Tube Lens |
|---|---|
| Olympus 2X 0.5 NA | Olympus 1X 0.25 NA |
| (EFL = 45 mm) | (EFL = 90 mm) |
| Olympus 2X 0.5 NA | Thorlabs 50 mm |
| (EFL = 45 mm) | f/0.95 (MVL50HS) |
| Nikon 5X 0.5 NA | Thorlabs 50 mm |
| (EFL = 20 mm) | f/0.95 (MVL50HS) |

Working designs of meso-SCAPE are capable of providing high-speed 3D imaging of large (multi-mm field of view) samples (FIG. 12A). Lower magnification O1 lenses mean lower NA and thus shallower angles at image rotation between O2 and O3. With 0.5 NA at O1, a simple 1× free-space interface at O2/O3 would not permit detection of any light. We show a O.5× version which was effective but had low throughput. An alternative is to use a fiber optic taper with 1.0 NA fibers on its front surface, which can be positioned at the intermediate oblique image plane. Taper pitch can now be ˜2.5 microns, making it feasible for imaging with moderate resolution, as seen for the systems depicted in FIGS. 12B-D.

### Section 13

### Meso-SCAPE with Beveled Taper

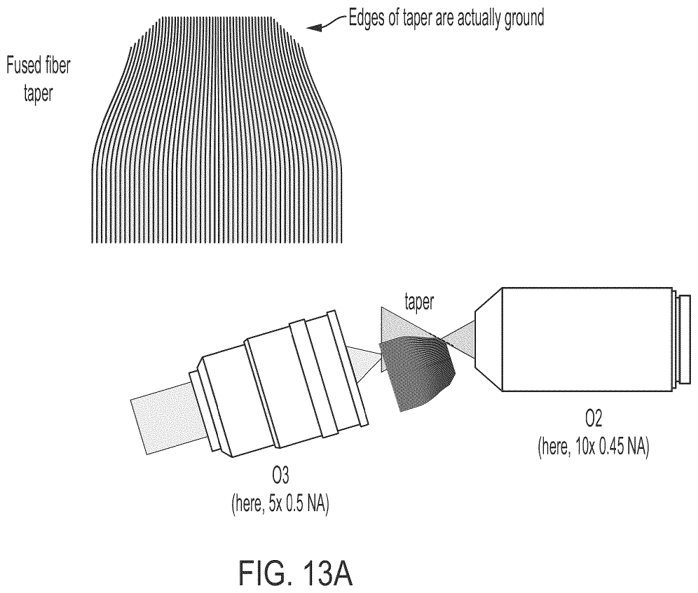

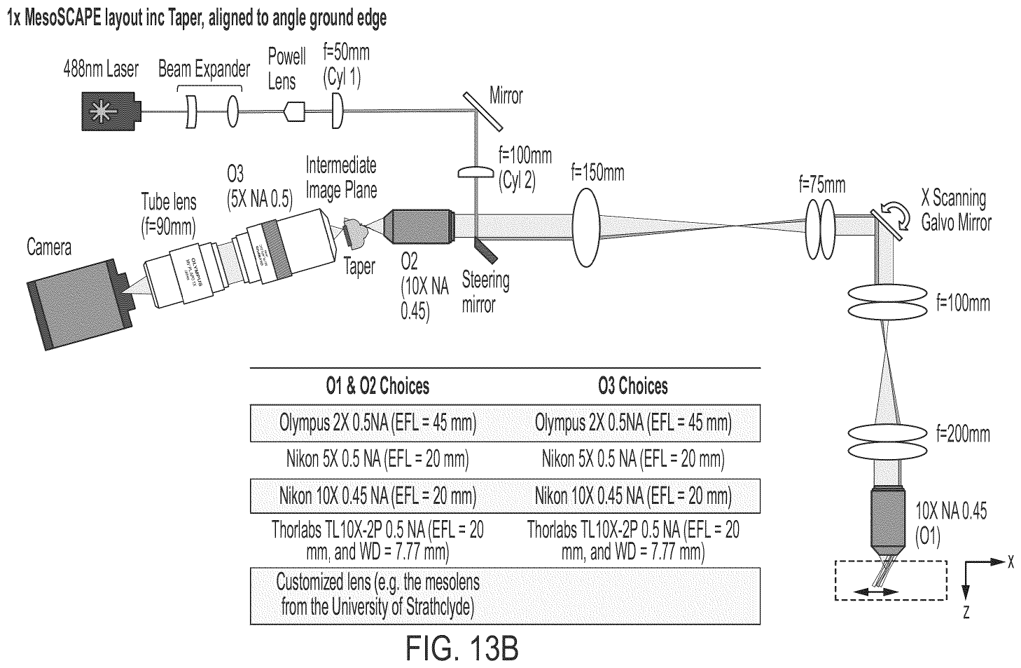

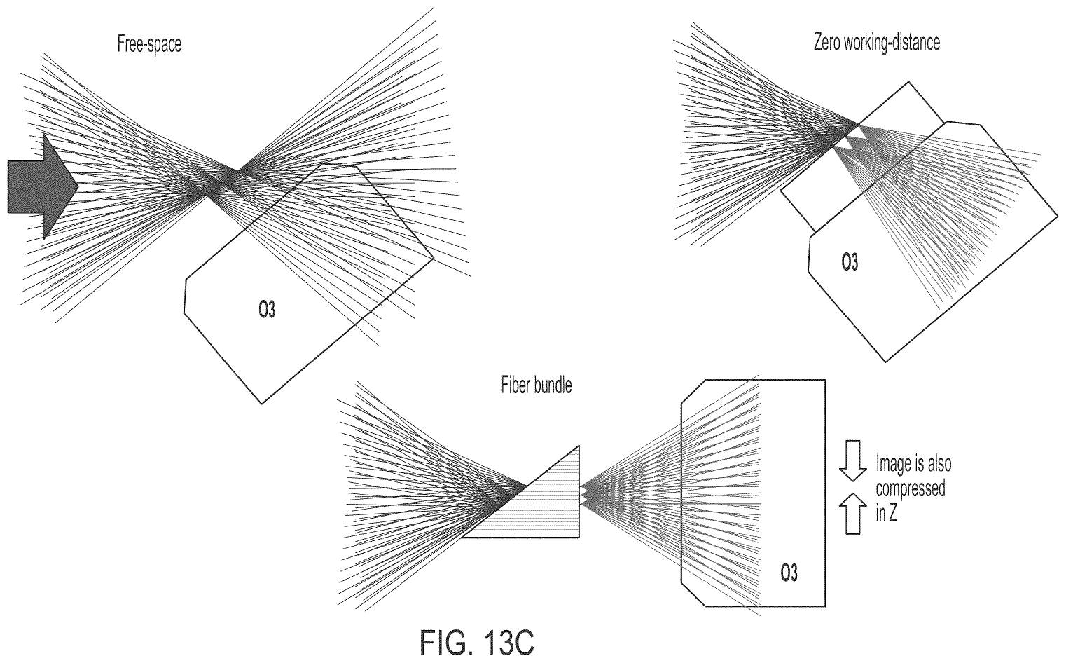

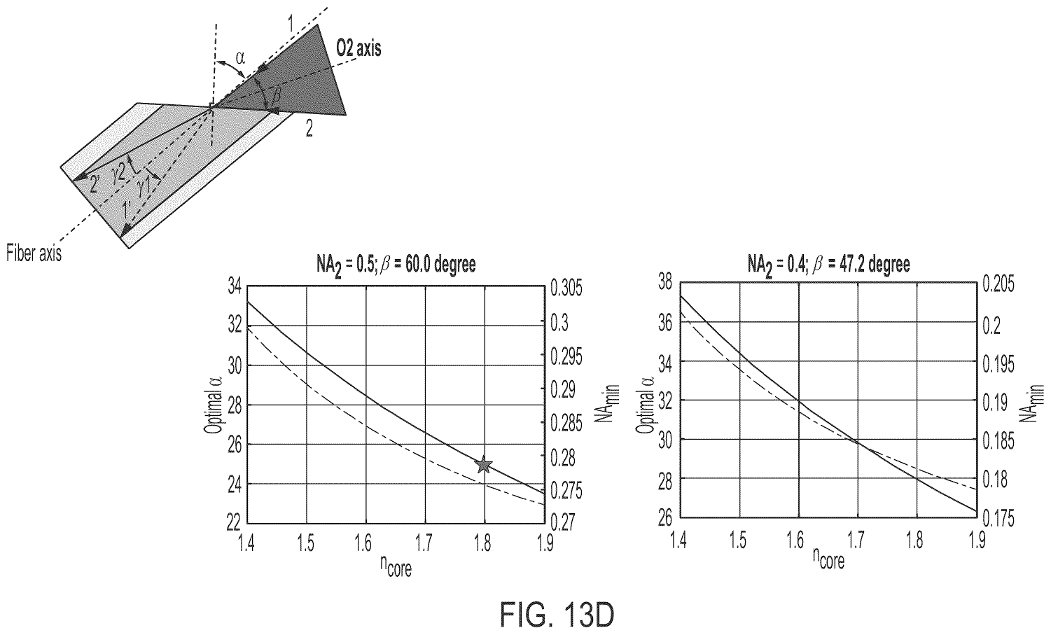

Notably, by polishing an angled bevel into the front face of the fiber taper (or uniform fused fiber bundle), it becomes possible to achieve image rotation without requiring a steep acceptance angle (FIG. 13A-D). While the beveled face needs to be aligned to the oblique intermediate focal plane, the ideal angle cut of the bevel relative to the fiber direction depends upon the material's refractive index, and can be optimized, as shown in FIG. 13D. One can optimize this angle to ensure that the central ray of the detected cone propagates along the center of the fiber, or that the angle of light coming out of the fibers is minimized. For fibers with a <1.0 NA acceptance angle, the bevel angle can be cut to ensure that the majority of light propagates along the fiber at greater than the fiber's critical angle (effectively making the fiber behave as if it has 1.0 NA). In both cases this optimization can permit maximal detection using lower magnification objectives at O3.

As with the en-face use of a 1.0 NA bundle, this approach removes the constraint on O1 numerical aperture, opening up the possibility of using a range of different lenses with different magnifications, fields of view etc.

This idea has now been implemented using a sample tapered fiber and it works well-yielding at least 5× more light than free space alignment, and with less angular ray dependent distortion than using the fiber bundle as a simple high NA conduit. Although using a beveled fiber bundle conduit to relay and rotate the oblique image plane is discussed in US-20190196172, the current embodiment demonstrates the feasibility of this approach using newly available fused fiber bundles (e.g., from Schott glass) with small enough fiber pitches to provide a substantial improvement in resolution.

It is important that the size of the fibers in the bundle are smaller than the desired resolution at the sample. Referring to FIG. 13A, the existence of the illustrated tapered fiber with fibers spaced at a 2.5 micron pitch at its narrow end provide a significant improvement compared to the initial concept of a non-tapered bundle (although the bundle itself doesn't necessarily need to be tapered and change size). The edges of the taper are ground and preferably ground and polished to provide the desired angle. Aligning the oblique intermediate image into the polished, angled edge of the taper permits much more light throughput and greatly reduced aberration. It further removes high NA requirements for image rotation. In alternative embodiments, beveled non-tapered bundles with smaller diameter fibers could be used to reduce clipping in the O3 arm. This approach yields measurable advantages over standard SCAPE systems (that are compatible with the lower spatial resolution requirements of Meso-SCAPE). (FIG. 13A-D)

In these embodiments, the incident light does not enter the fiber bundle at steep angles (on average), producing much less aberration in imaging the back surface of the bundle to the camera because angles are more complete. This means that the bundle does not need to have very high NA fibers—they only need to match the NA of O2 (with adjustment for some effects of an oblique cut surface of the fibers at the intermediate image plane.

The collection efficiency of the fibers is high as all light coming from O2 enters the fibers in approximately their orientation direction (accounting for refraction and the angled surface), particularly if the front surface is anti-reflection coated.

For the beveled design, the NA of the fibers is less of a concern, which opens up more options for fiber conduits. Some light will be lost to packing fraction and cladding in the current configuration, but this is outweighed by light gained from more direct filling of the fibers. While the orientation of the beveled face must match the sheet angle, there can be a gain to having the light entering the fibers on an angle relative to their axis to better bend the light into the fibers based on refraction.

Referring now to FIG. 13D, by optimizing the bevel angle and the refractive index of the core and clad of each individual fiber, the two refracted marginal ray, (ray 1 to ray 1′, and ray 2 to ray 2′), can be made symmetric relative to the fiber axis, thus minimizing the overall angle of output light cone. Note that the bevel angle can be selected independent from the sheet angle out of O2. In FIG. 13D, a is the angle between fiber axis and bevel normal; and is the full cone angle of O2. The two marginal refracted rays follow the following equations:

$${γ}_{1} = α - arcsin ( \frac{cos β}{{n}_{core}} )$$

$${γ}_{2} = arcsin ( \frac{1}{{n}_{core}} ) - α$$

To minimize fiber output NA, we want γ₁=γ₂, therefore

$$2 α = arcsin ( \frac{1}{{n}_{core}} ) + arcsin ( \frac{cos β}{{n}_{core}} )$$

Also for given optimal α, the minimal fiber NA should be NA_{fiber}≥n_{core}·sin γ₁. For example, For NA_2=0.5, i.e., β=60°, and n_{core}=1.8, the optimal bevel angle α≈25° and minimal fiber NA should be ˜0.3. In some preferred embodiments, we have:

$$β = 26 ° \times 2 ,$$

$$α = 45 ° ,$$

$${n}_{core} = 1.8$$

Note that the bevel angle is far from the optimal value of 26.9°. The outgoing limit angles are then:

$${γ}_{1} = 25. ° ,$$

$${γ}_{2} = - 11.3 °$$

So the limiting incident NA into the small end is

$${NA}_{in , max} = sin ( {γ}_{1} ) \cdot {n}_{core} = 0.76$$

And the output maximal NA from the big end is then

$${NA}_{out , max} = {NA}_{in , max} / 1.4 = 0.54$$

Objectives that are suitable for use in the FIG. 13A-D embodiments include the Mitutoyo 12× NA O.53 MI PLAN DC57 WD10 O1 and the Olympus MV PLAPO 2XC. This design thus opens up further potential to use even lower NA primary and secondary objective lenses. The table in FIG. 13B shows some lens combinations that work well in these embodiments.

With thinner fibers at the front surface (or throughout) the fiber bundle, this could be a viable method for SCAPE imaging at all scales, not just large field of view meso systems.

The potential limitation of the ZWD lens approach on imaging depth (owing to curvature of the oblique plane between O2 and O3) may be less impacted by the fiber bundle approach because light propagation directions become scrambled within each fiber, which should reduce the impact of defocus.

Currently, the smallest available front-face fiber pitch is 2.5 microns. The ‘taper’ does not need to be an actual taper, it could be a straight fiber conduit with no magnification change and lower than 1.0 NA collection angles. Ways to improve sampling density if constrained by fiber pitch size include the following four examples:

Example 1: Adjusting the magnification of the system, e.g. using a 2× magnification (rather than 1×) between O1 and O2 from a higher NA O1 lens would lead to a shallower, yet manageable angle after O2 (given the ZWD of the beveled fiber bundle, assuming 1.0 NA) and thus the 2.5 micron pitch of the fibers would map to 1.25 micron sampling density at the sample. Although the ‘perfect imaging condition’ would be lost, the effect is small at this still relatively coarse sampling density.

Example 2: Asymmetric (e.g., unilateral) magnification within the O2 telescope can also be valuable-if the image is magnified onto the beveled taper in the Y direction, the sheet angle should not change. Sampling density along Y would be increased (e.g. to <1 micron) while X-sampling is dictated by the galvo scanner. Only the Z resolution would be affected by the fiber size, which could be manageable given that competing technologies typically under-sample along Z.

Example 3: We note that the angled bevel actually compresses the image in the y-direction which could be advantageous to enable faster imaging with fewer rows on the camera along z (which should be acceptable for multi-plane imaging especially if the PSF in Z is elongated owing to the shallower crossing angle between the light sheet and detection cone at the sample).

Example 4: The whole current Meso-SCAPE system works with free-space (air) coupling at the sample opening up potential for non-contact 3D imaging for a large range of applications. Currently applying to imaging large areas of mouse brain, whole bodies of zebrafish larvae, whole hydra (genetically modified to express fluorescent indicators) and large-scale high-throughput imaging of cleared tissues such as human brain samples. However, this approach could also be incorporated with immersion lenses. Immersion at O1 would introduce the requirement for magnification between O1 and the intermediate image plane, with higher refractive index at the sample magnifying the image onto the conduit, improving sample density.

Sampling resolution of the bundle can be improved using one or more of the following approaches:
Relay image through an actual GRIN lens that forms an image.
GRIN lens microarray->each element in the array generates a resolved image.
Computational imaging of output from each fiber to resolve images.
Dithering of the fiber bundle position, or dithering the image on the front surface to effectively ‘upsample’ the image (as in the human eye).
Adjust magnification to 2× between 1 and O2 and decrease angle->magnifies image onto fiber bundle to 1.25 microns. Adjust bevel angle to accommodate.
Immersion objectives at O1 would mean magnifying the image at O2 improving effective sampling density on the fiber bundle by n2/n1. The z-direction sampling of the fiber bundle is determined by the bevel angle, but will effectively compress the image on the camera in the z direction. The benefit here is that fewer rows need to be acquired on the camera->increasing frame rates without reducing y-dimension sample density (preferable for multi-plane imaging where z resolution will be lower anyway).

### Section 14

### Ruled Grating-Based Image Rotation.

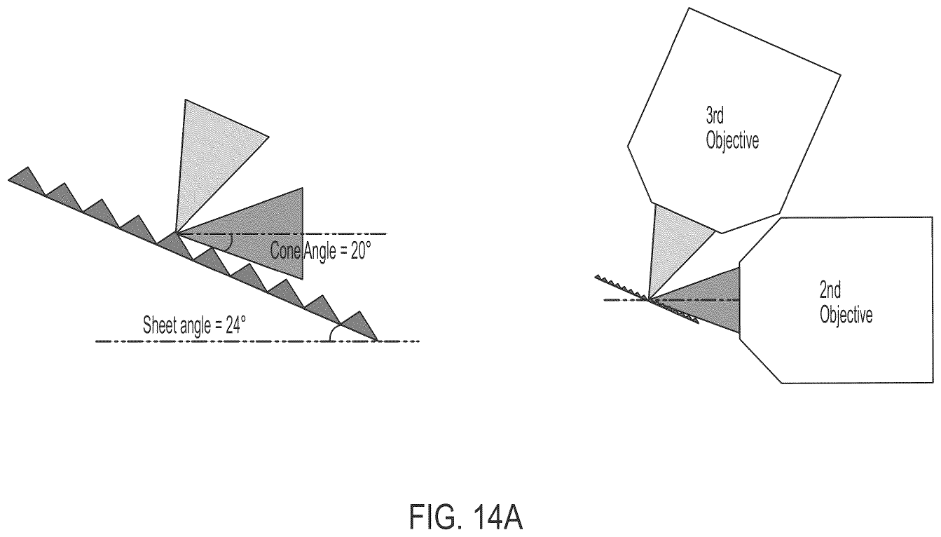

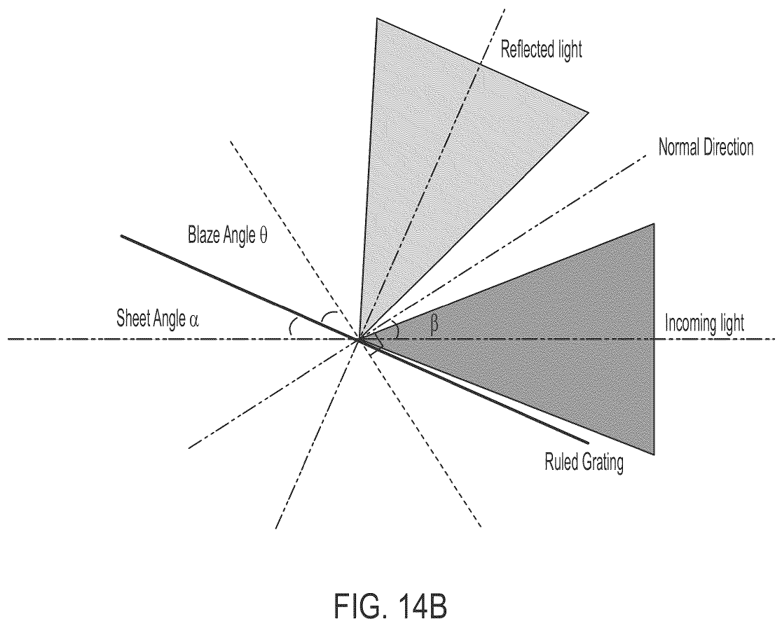

FIGS. 14A-B depict how the fiber bundle concept is effective because it breaks up the image into smaller parts for rotation. A similar approach can be achieved using a grating as a series of micromirrors.

Thus, by making sure that the third objective (3) is perpendicular to the grating surface, we can ensure an in focus image on the camera.

Prior embodiments have used a diffractive process to rotate the beam angle whereas the embodiments described in this section use the ruled grating purely as a reflective element. Here, the ruled grating provides a unique advantage to separate the global reflective plane and the local reflective surface, such that the third objective can actually collect the light.

Advantages over prior systems include the following: First, it is conceivable that the feature size (PSF) must be several times bigger than the grating groove density so as to ensure an effective diffraction process. After all, no diffraction can take place if the feature is smaller than the grating groove. Prior systems achieved a PSF of ˜3.1 μm, which lower than the diffraction limit (NA=0.28), given their grating period (d=555 nm). However, this method may thus not be compatible with use of a 0.5 NA lens used in meso-SCAPE systems described above. There is no such limit if we use the 0^{th} order instead of the 1^{st} order of the grating output, since the underlying physical phenomenon is different.

Second, a diffractive system is wavelength dependent. It is true that the final image won't be blurred since the grating is placed at the image plane. However, the angular rotation does change as a function of wavelength. From the grating equation:

$$\frac{m λ}{d} - sin ( α ) = sin ( β ) ,$$

$$with$$

$$m = 1 ,$$

$$d = 555 nm ,$$

$$α = 75.4 ° .$$

For λ=515 nm (GCaMP) the angle β is 2.27°. For λ=674 nm, the angle is −14.3°. A 16.5° difference corresponds to a 5.9 mm shift at the Fourier plane of the objective, which will shift a large portion of the light out of the collectable area. It is therefore nearly impossible to use GCaMP with far red-shifted dye simultaneously in prior systems.

Referring now to FIG. 14B, from the geometry, θ=β, α+2 θ=π/2. So, for example, for a sheet angle of 24.6°, the blaze angle needs to be 32.7°. Similar products can be found from Richardson and EO. Progressive lenses (also referred to as “graded lenses”) are now commonly fabricated in eyeglasses to produce variable focal lengths dependent on the part of the lens being viewed. Incorporation of such graded lens into SCAPE could potentially permit complete or partial image rotation.

### Section 15

### Greater-SCAPE (Human Brain Optimized Light Sheet—HOLIS)

This section relates to imaging very large (cleared/expanded) samples with high throughput. It also addresses issues of variable refractive index between samples cleared in different ways.

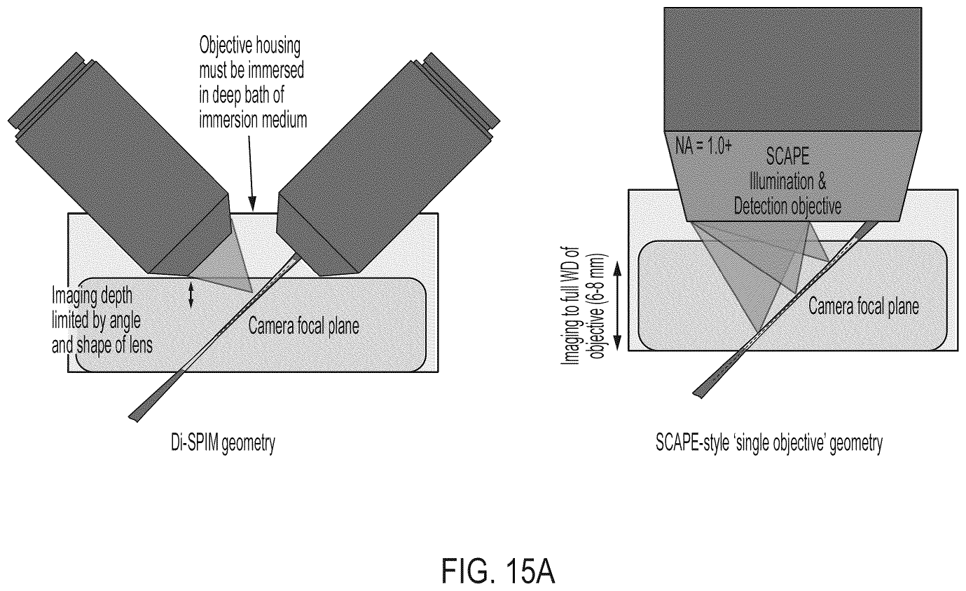

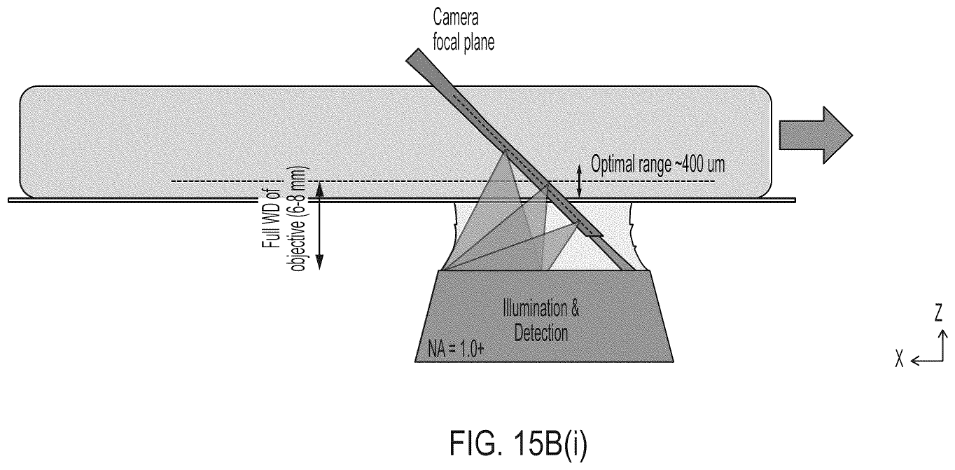

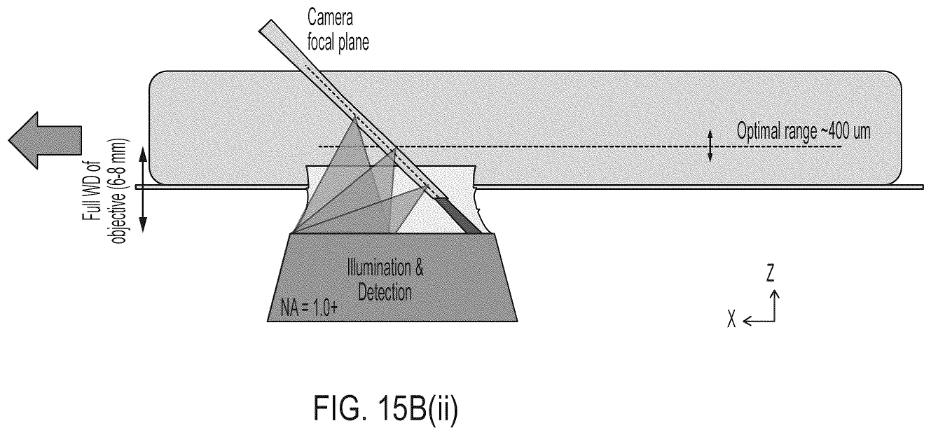

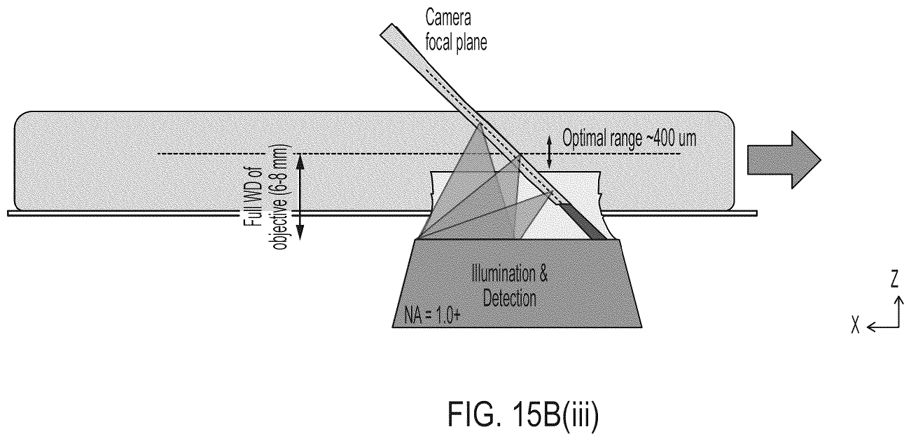

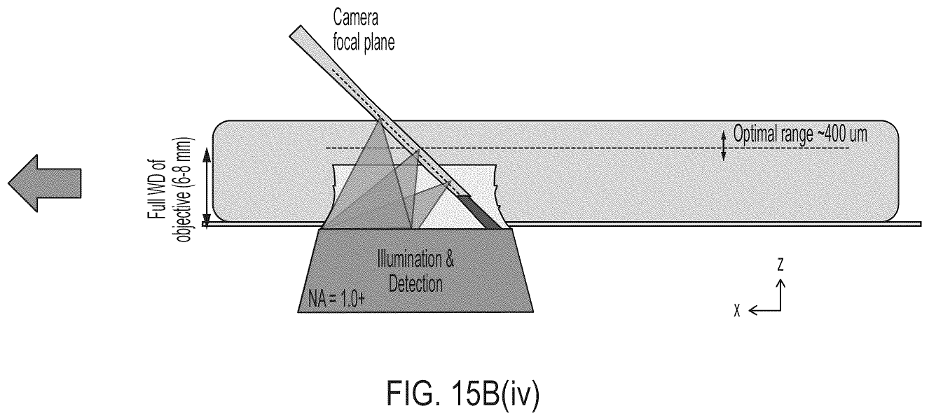

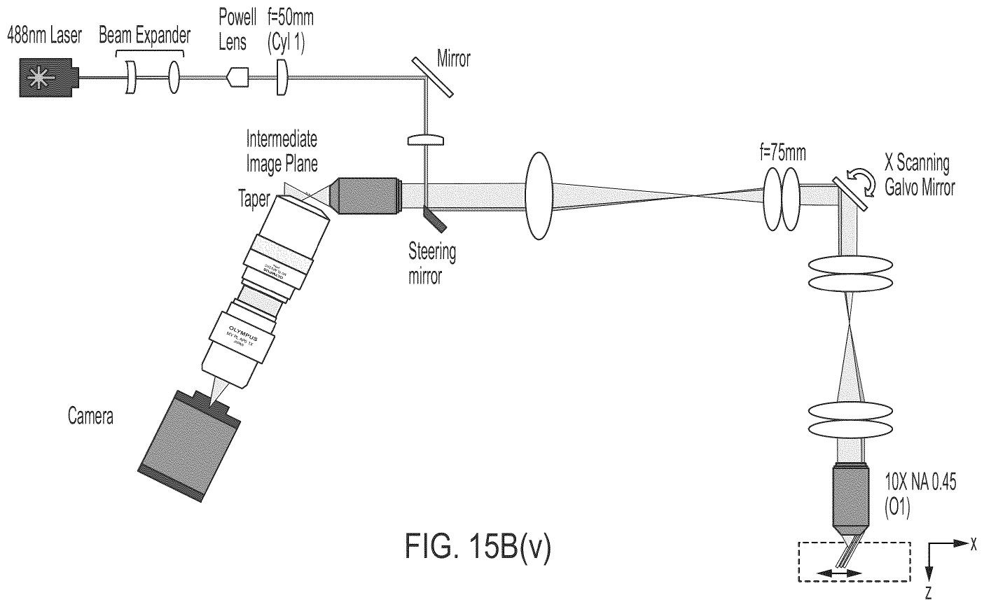

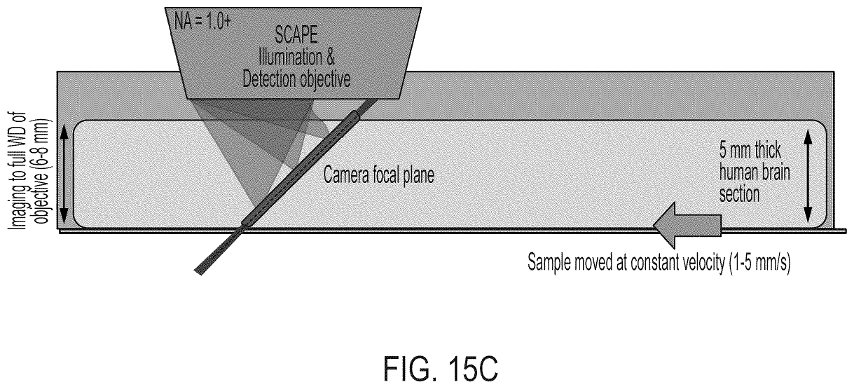

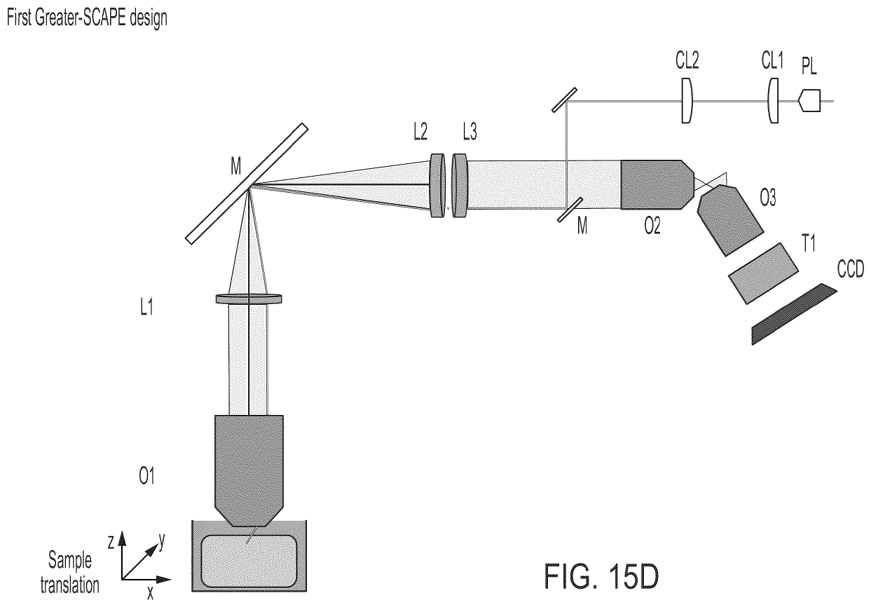

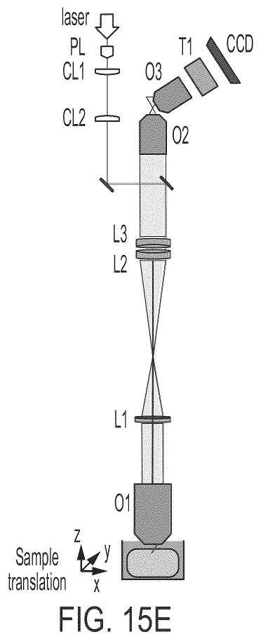

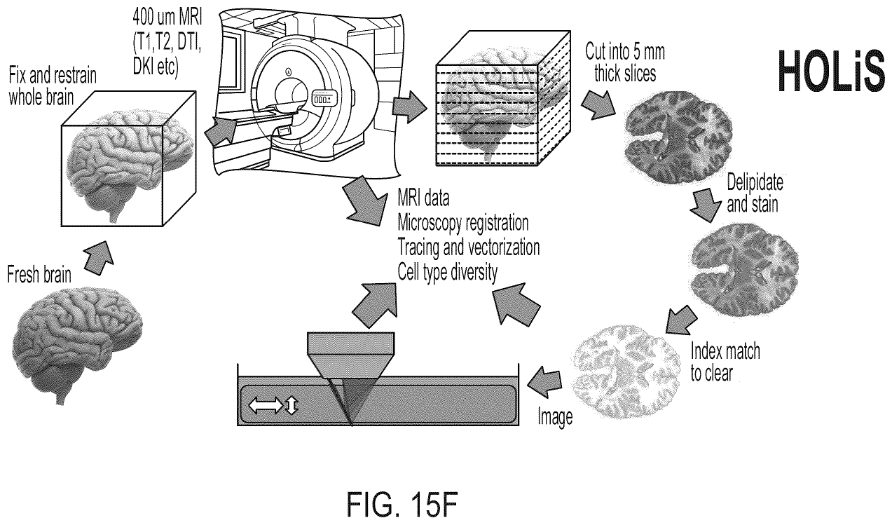

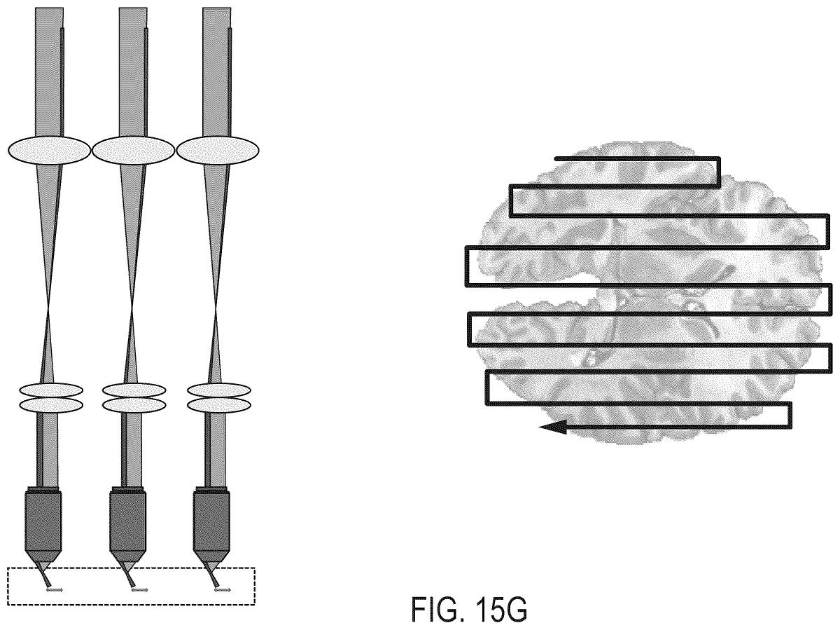

Our results published in Voleti et al., Nature Methods 2019, showed high-speed SCAPE imaging of large, cleared tissues. In many cases, the best implementation is to keep the SCAPE light sheet stationary and move the sample laterally (along x). The advantage of using a single objective light sheet geometry for this compared to ‘di-SPIM’ type angled geometries that use two objective lenses, each at ˜45 degrees to horizontal and 90 degrees to each other (as depicted in the left panel of FIG. 15A) are the following:

A single objective geometry should be able to image all the way into an intact sample, to the limit of the lens's working distance. Only reduced immersion medium is required (the depth of the working distance—half the depth imaging range). Dual objective approaches face many challenges for sample positioning and achieving a usable working distance into the sample without colliding with the sample surface, while significant immersion medium is needed to immerse large amounts of the oblique objective lenses. Immersion medium can be expensive and can degrade as it evaporates during long duration imaging sessions. Both launching and collecting light through objectives oriented at an angle to the sample, particularly in inverted geometries that require a barrier such as glass, can introduce distortions, and immersion media challenges and make alignment challenging.

Our implementation of SCAPE is also potentially significantly more efficient and rapid that implementations of others, for example: Our use of a Powell lens (which could be replaced with a spatial light modulator or other phase clement) generates a relatively uniform light sheet across Y. This permits imaging with a static light sheet, illuminating all locations on the sheet simultaneously, permitting the camera to detect light from all pixels for the full duration of the frame. Most designs use ‘digital line scanning’ in which a pencil beam is scanned back and forth along the Y direction to generate a uniform sheet, however this approach decreases the amount of time each pixel is imaged. To achieve the same signal, the pencil beam will need much higher fluence (power per area2) to account for this reduced integration time, a condition likely to result in more photobleaching than lower fluence imaging for longer duration when using a static sheet.

Only a subsection of the camera chip (i.e., the subsection that corresponds to the number of rows being imaged/in best focus) needs to be used. This reduced number of rows increases achievable frame rates and thus volumetric imaging speeds and/or x-direction sample densities. Optionally, multi-color excitation and emission separation can be used with these “greater SCAPE” embodiments. Imaging of many different fluorescent labels in parallel can greatly increase imaging and tissue processing throughput (described further below).

Our approach with the stationary light sheet is to collect images from the camera continuously as the sample is translated at constant velocity. This approach means that images are acquired continuously during motion and thus it is not necessary to account for x-direction sample movement in the time budget for overall imaging of large samples. This approach has the effect of maximizing signal integration time (such that if rolling shutter modes are used, there is almost continual exposure of the camera). In the case of very large samples, even a 1 second delay for moving the sample across in X to tile adjacent regions could add days or weeks to the overall acquisition time.

Using a Gaussian light sheet, the narrowest part of its waist spans a particular depth range, while remapping the focal plane to the intermediate image plane is only going to be aberration free over a limited depth range. It is thus common to acquire images of thick samples by repositioning the waist of the beam to different depths. This can be achieved by adjusting the focal depth of the sheet and image plane, or by moving the sample to different distances away from the objective lens. One way to do this with our system is depicted in FIGS. 15B(i-iv). This approach was effective for imaging expanded, cleared tissues to a depth of 2 mm in our Voleti et al, Nature Methods 2019 paper. Z-direction scanning is also effective for covering the full depth of the sample without needing to stitch images, using the design depicted in FIG. 15E.

Over a more limited range, this adjustment of Z position could also be achieved by adding a lens element to the Ol telescope arm such as an electrically tunable lens (e.g., as depicted in FIG. 15B(v). In this case, light entering the back of O1 can be adjusted to be slightly convergent or divergent to alter the Z position of the beam waist in the sample. The lens can also have the effect of correcting the light coming back from the sample to adjust the focus of the detection system to the light sheet waist. This element would need to be positioned at the equivalent of the back focal plane of O1 to avoid adjusting the width of the light sheet along Y or the mapping of the beam onto the back focal plane of O1. This would require the addition of a relay lens system in the O1 arm since the BFP is often positioned within the body of O1. Such an embodiment could be used in conditions where fine adjustment of the physical position of O1 with respect to the sample is not possible. Alternatively, the Z position of O1 could be slightly adjusted (e.g., over a 500 micron range) without significantly impacting the condition of mapping the back focal plane of O2 to key focal planes in the system.

However, anything that can be done to extend the usable depth range (along the oblique plane z′) and image without additional translations has the capacity to significantly improve imaging speeds and reduce photobleaching, as illustrated in FIG. 15C. There can be helpful benefits with the use of lenses to correct refractive index-based distortions and aberrations when imaging deeper into cleared samples. Some come with motorized collars that can be adjusted based on the relative position of the lens and the sample. For lower magnification/coarser imaging, if a focus can be maintained over a sufficient depth of field, more depths can be acquired at once in a single frame, greatly improving imaging speed, and reducing analysis time needed for stitching. Optionally, these embodiments can employ beam shaping/TAG lens/SLM based generation of a more uniform sheet along Z′->or waist scanning synchronous with row read-out of the camera. Optionally, these embodiments can rely on sheet uniformity/multi-angle projections to reduce shadowing. Preferably, these embodiments minimize scattering and depth-dependent aberrations. Preferably, these embodiments accommodate the range of refractive indices used for current clearing methods (ranging from ˜1.43 to 1.56).

We have built a version of Greater-SCAPE to image very large, cleared, thick samples such as processed human brain. Using a long working distance (6 mm) 1.0 NA objective lens, the inventors confirmed that imaging up to 6 mm deep into cleared tissue can be achieved using the design depicted in FIG. 15D. However, we found that refractive index can be a major issue for achieving good images, especially over depth and extended depth of fields. We have found that for this kind of lens, we need to carefully match the refractive index of the sample to the lens' design parameters. In some cases, this issue could be addressed using a motorized correction collar that can be adjusted for different samples, or adjust for aberrations imaging deeper into samples. A suitable set of components for use in the FIG. 15D embodiments appears below in table 7:

TABLE 7

| | |
|---|---|
| O1 | HC FLUOTAR L 25×/1.00 IMM, 6 mm WD |
| | (ne = 1.457) motCORR VISIR (Leica) |
| O2 | Plan Apo Lambda 20×/0.75 (Nikon) |
| O3 | Edmund Optics 20x, 0.6 |
| PL | 30 degree Powell Lens |
| CL1 | 50 mm cylindrical lens |
| CL2 | 200 mm cylindrical lens |
| M | mirror |
| L1 | Leica 200 mm tube lens |
| L2 | 400 mm achromatic doublet |
| | (171 mm Plossl lens) |
| L3 | 300 mm achromatic doublet |
| | (171 mm Plossl lens). |

Notably, the FIG. 15D embodiment does not use galvo-based light-sheet scanning, although such scanning could be included if needed.

‘Multi-immersion’ lenses are another option which have the property of changing their magnification with changing refractive index of the medium/sample. In some embodiments, a multi-immersion lens with a concave front surface is used, which enables it to focus in a range of different refractive index immersion media. One example of a suitable multi-immersion lens is the applied scientific instrumentation multi-immersion objective 54-12-8, which has an NA of 0.7 and a WD of 10 mm. The magnification of the lens changes as the refractive index changes.

To get ‘perfect 3D imaging’ in SCAPE, the magnification between the sample and the intermediate image plane needs to match the ratio of the refractive indices of the medium at the sample/intermediate image plane. For water at the sample, and air at the intermediate imaging plane we use a magnification ratio of 1.33.

It has been recognized that if the refractive index of the medium causes the magnification of the primary lens (1) to change, that this could in fact correct the ratio of the magnifications mentioned above to match the ratio of the magnifications, maintaining the desired imaging condition.

Table 8 below depicts a set of parameters that is suitable for use in these embodiments.

TABLE 8
Properties of commercially available multi-immersion lenses

| Parameter | Example 1 | Example 2 | Comment |
|---|---|---|---|
| Numerical | 0.4 @ | 0.7 @ | NA proportional to RI |
| Aperture | RI 1.45 | RI 1.45 | |
| Immersion | 1.33-1.56 | 1.33-1.56 | Includes all major |
| Media RI | | | clearing solutions |
| Effective | 12 mm @ | 8.4 mm @ | Magnification |
| Focal Length | RI 1.45 | RI 1.45 | proportional to RI |
| Working | 12 mm | 10.0 mm | |
| Distance | (for all RI) | (for all RI) | |
| Flat Sample | 5.1 mm | 2.0 mm | Imaging depth into flat |
| Depth | | | sample at 45° tilt |
| Field of View | 1.2 mm Ø | 1.0 mm Ø | |

A multi-immersion objective lens configuration of Greater-SCAPE works very well. The mapping to O2/O3 assumes 1.45 magnification for O1 effective focal length of 8.4mm. As the refractive index of the sample changes, so too does the EFL and thus the magnification adjusts to maintain the imaging condition and sheet angle at the intermediate image plane. 600 micron depth of field (oblique z′ imaging range) seems feasible. High speed image acquisition is obtained in spite of low collection angle with O1 having only 0.7 NA (28° half-cone). The multi-immersion properties of this lens appear to not only tolerate changes in refractive index of the medium between samples, but to provide longer focal ranges (simultaneously) than other long-working distance higher NA lenses tested, which may be due to the multi-immersion aspect of the lens's design.

In the case of SCAPE (or other single objective light sheet configurations), these magnification changes can cancel out the effects of refractive index changes yielding a consistent intermediate image plane irrespective of changes in the sample. This possibility has strong potential to be important for our Greater-SCAPE design.

Referring now to FIG. 15E, the inventors built a system using a 0.7 NA multi-immersion lens and confirmed its ability to image to depths of over 8 mm in cleared sample, while tolerating samples of a range of different refractive indices well. A suitable set of parameters for use in this design is as follows:
O1=ASI 0.7 NA multi-immersion lens
O2=Edmund 0.6 NA air 20×
P3=Olympus 0.75 NA air 0×
PL=30 degree Powell Lens
CL1=50 mm cylindrical lens
CL2=200 mm cylindrical lens
L1=200 mm achromat
L2=400 mm achromatic doublet (171 mm Plossl)
L3=300 mm achromatic doublet (171 mm Plossl)
T1=50 mm Tube Lens

Using a 0.7 NA lens as O1 does reduce collection efficiency with air-coupled detection at O2-O3 (as in meso-SCAPE above). By the same approach we can consider that if lower spatial sampling can be tolerated, this lens could be combined with either the front face or the beveled fiber optic conduit concepts described above in connection with FIG. 12B-D.

Zero working distance approaches could also be valuable here to accommodate reduced O1 NA while providing higher potential sampling densities and scalable imaging compared to the fiber optic bundle approach. Use of our ‘blob’ approach to manufacture ZWD lenses from available immersion objectives could afford access to larger fields of view than currently available commercial ZWD lenses.

It is possible to make custom zero working distance lenses to achieve the desired properties of around 1.0 NA at O2 with as large a field of view as possible.

We note that the required magnification of this system will cause the intermediate image of the sample between O2 and O3 to be magnified, thus requiring O2 and O3 to be able to accommodate a larger field of view than O1 to map the full field of O1 to the camera. However, this condition also reduces the required NA of O2 relative to O1 compared to an air-air system, with higher refractive indices used for clearing (compared to water) permitting the use of longer working distance lenses such as the Edmund optics 20× 0.6 NA air lens as O2.

Eventual implementations can incorporate technologies for sample loading and scanning, optimized for large samples. Robotic and automated positioning (or magnet-keyed), and detection of scan ranges can be used to provide unsupervised imaging over the course of several days for widespread adoption of this approach. Scan pattern optimization will particularly depend on the maximum range of Z that can be acquired in parallel-for which light sheet engineering approaches beyond Gaussian beams including SLM and phase plate based generation of extended patterns can be used. A sheet that contains a range of angles of incidence in the y-direction (in-plane) to reduce shadowing artifacts deeper into samples can also be used. Many of these concepts are combined and optimized for the application of scanning large samples.

In some cases, there may be concern that acquiring images during continuous motion of the stage will introduce blurring or scan direction-dependent distortions of the image (owing to read out of different rows of the camera being read out at different times when using rolling shutter settings). In some embodiments, this problem is overcome using a galvanometer mirror (as in SCAPE) to rapidly adjust the position of the light sheet and detection plane to hold it stationary relative to the moving stage during each image exposure. However, this approach adds complexity and requires precision timing while wasting exposure time of the camera through the use of global shutter mode. Global shutter or global shutter reset mode could be used alone to minimize the spatially dependent effects of camera read out during motion, reducing the influence of scan direction. And while this approach does not keep the imaging plane stationary, the image produced will simply be integrated over the distance between each x-step providing continuous sampling. In the event that very fine tuned imaging of a plane is required, one could gate laser illumination times to only a very short period compared to the overall integration time of each camera frame. Each laser flash would need to be triggered to occur during exposure of the camera frame. This approach would require much higher instantaneous laser power, but could use the same average laser power over time and is achievable with modern high-power, temporally modulatable lasers. A final approach to this issue is post-hoc registration or correction of images, or analysis of images in uncorrected space and registration of extracted information in a corrected coordinate space given knowledge of these effects.

These embodiments are useful for high speed imaging of expanded tissue samples, and the application of this technology to in-situ sequencing, for example.

In the FIG. 15A-E embodiments, the collection angle/NA/throughput could be greatly improved by either the fiber bundle or ‘blob’ methods to replace the free-space O3.

The blob on a 20× 1.0 NA 2 mm WD lens could yield a ˜1.2 mm field of view with a wide range of resolutions->from diffraction limited to coarsely sampled at low magnification.

Larger field of view 1.0 NA water immersion lenses (or other immersion) can be highly desirable for O1 and O3 (with ZWD blob).

For larger fields of view, the ZWD, fiber bundle/taper at O3 could provide high throughput despite a lower NA O1 multi-immersion lens such as the 4× 0.35 NA (9.1 mm FOV) or 12×0.53 NA (2.3 mm FOV) super-plan lenses from Mitutoyo.

With a 1.45 magnification from O1 to O2, the effective sample density of the fiber bundle would improve from 2.5->˜1.8 microns in Y. The bevel angle would dictate the Z sample density, but the effective compression of the image in Z caused by the bevel would also permit acquisition of fewer rows on the camera compared to Y-direction sampling, thereby increasing the effective frame rate.

Optionally, the magnification of the telescope could be increased to 2× from O1 to O2 to increase the size of image, and the fiber bundle bevel is adjusted to compensate. Assuming good collection efficiency and minimal aberrations affecting 3D re-mapping, 0.9 microns per pixel could be achieved.

FIG. 15F depicts a system named “HOLIS” for imaging an entire human brain. It captures images as quickly as possible by combining many of the innovations detailed herein-including spectral multiplexing and improving resolution, throughput, and field of view. It uses methods for holding and embedding the brain, slicing it precisely into sections (e.g., ˜5 mm thick). Staining and clearing the brain slabs. Registering processed slices into cassettes. Loading cassettes into imaging system which will rapidly translate the slices under the SCAPE/HOLIS imaging head. Information about location and slice ID will be stored for automated stitching/registration and multispectral analysis of resulting 3D images to enable mapping of cell types, connections, and vasculature throughout entire human brains with an imaging throughput of under 1 week per brain.

Referring now to FIG. 15G, acquisition can be speeded up through parallelization of imaging. For example, multiple imaging heads could be arranged above the sample, or side by side to enable multiple streams of data to be acquired in parallel as the brain section is moved below. Imaging could also be performed from both sides of the sample at the same time (above and below). Although the Ol lenses we are working with have very long working distances (6-10+mm) it can be beneficial to acquire sub-sets of depth ranges to ensure good remote focusing and light sheet waist thickness.

### Section 16

### Alternative Orientations of Light Sheet with Respect to Detection

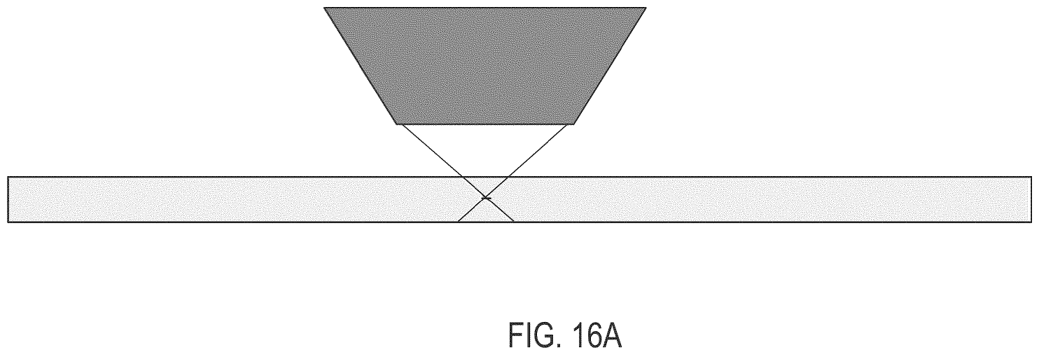

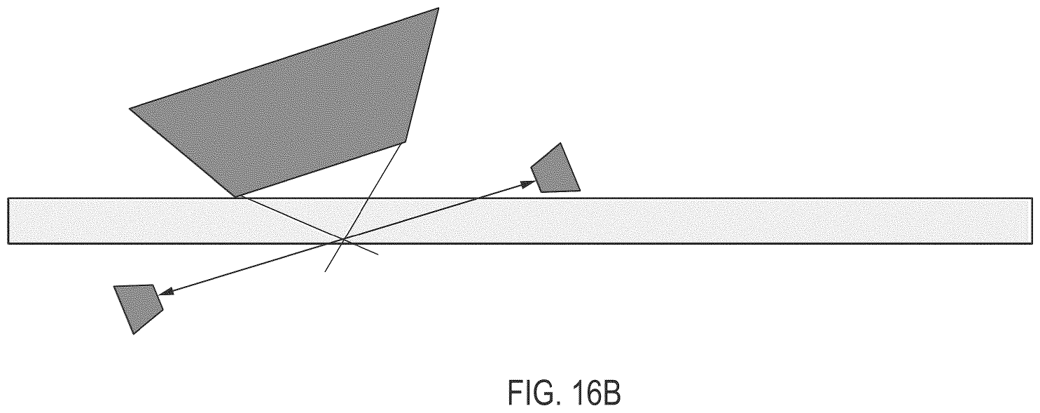

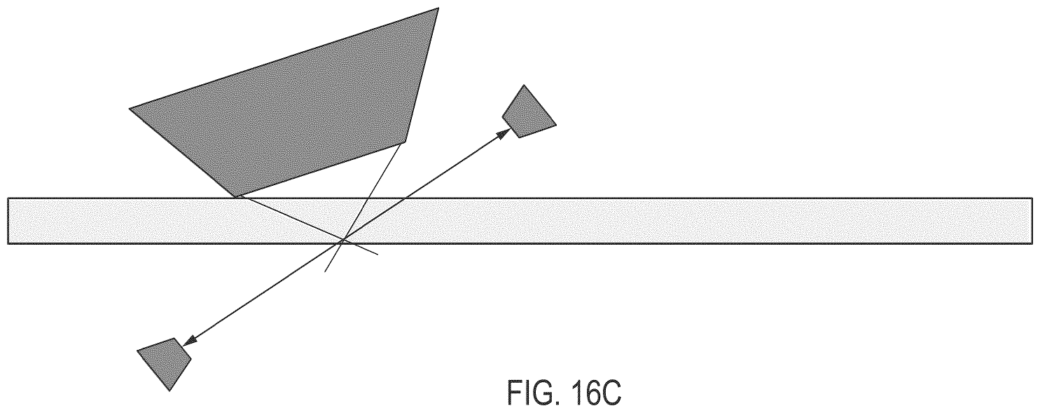

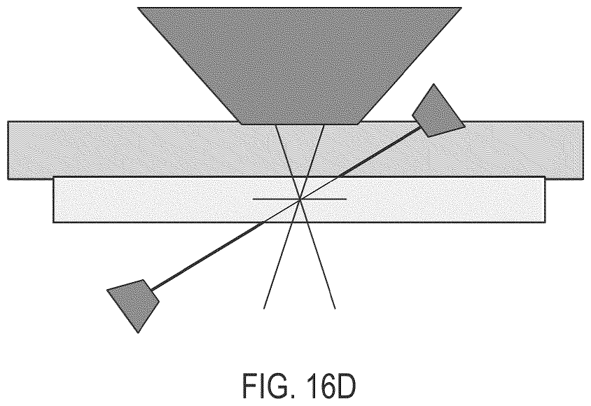

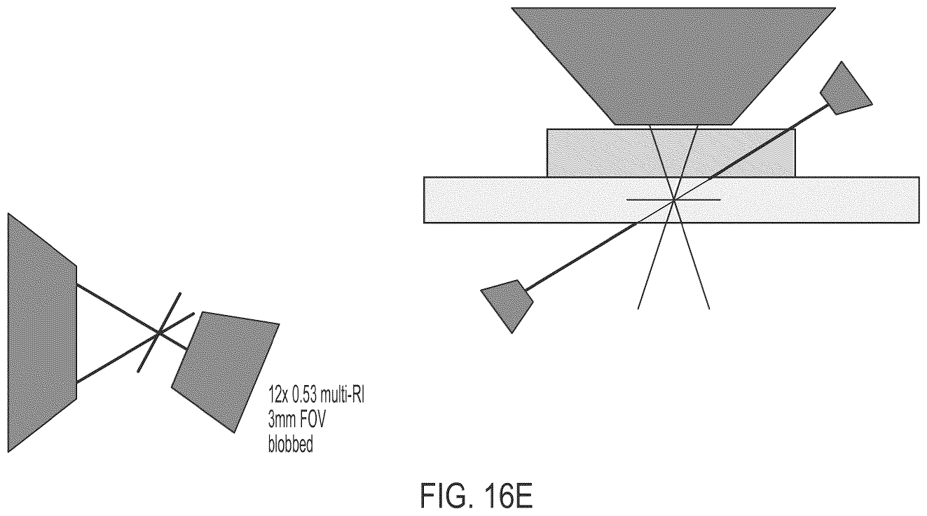

FIGS. 16A-E depict a range of configurations that deviate from the standard single objective light sheet approach. Whereas SCAPE typically leverages the single objective geometry to permit rapid galvanometric scanning of the light sheet (and descanning of the returning beam) for high speed 3D imaging of a 3D field of view, if acquisition is going to be performed with a static sheet there can be advantages to imaging with an externally introduced light sheet. The pros and cons of each of these approaches are listed below.

Pros for the FIG. 16A approach:
Very simple and robust alignment at sample->easy to automate and position
Lenses designed for en-face use, no effects of angle of front surface
Dipping
Up to 1.0 NA
Distance to beam waist is minimized and sheet NA can be adjusted over a wide range.

Cons for the FIG. 16A approach:
Z FOV limited by remote focusing defocus conditions.
Aberrations at edges.
Detection NA—hard to get all of it
Reduced crossing angle <90 degrees

Pros for the FIG. 16B approach:
can use full NA of lens (lattice 1.1?)
90 degree angle
Use full X-Y FOV of lens
With large FOV lens could feasibly image all depths at once without remote focusing constraints, assuming availability of large enough camera chip.
Could potentially illuminate from both sides simultaneously if needed

Cons for the FIG. 16B approach:
Need higher NA light sheet for small FOV, hard to make and position.
FOV still limited to ˜1×1 mm anyway
Using detection objective on an angle with respect to sample can cause aberrations. Aberrations will not match with aberrations of excitation.

Pros for the FIG. 16C approach:
Can use full NA of lens
Use full X-Y FOV of lens (although you technically can with single objective depending on how you introduce your sheet)
Easier to fit higher NA light sheet-waist scan
Requires remote focusing but reduces influence of defocus constraints on field of view.
Could potentially illuminate from both sides simultaneously if needed

Cons for the FIG. 16C approach:
Reduced crossing angle but better than single objective imaging.
Requires mild image rotation (thus re-imaging with an O2 and O3)

Pros for the FIG. 16D approach:
Uses primary objective en-face reducing aberrations
Can use full NA of lens
Use full X-Y FOV of lens (although you technically can with single objective depending on how you introduce your sheet)
Requires remote focusing but reduces influence of defocus constraints on field of view.
Could potentially illuminate from both sides simultaneously if needed

Cons for the FIG. 16D approach:
Reduced crossing angle (<90 degrees) but better than single objective imaging.
Requires mild image rotation (thus re-imaging with an O2 and O3)
Positioning of secondary illumination and tolerance of aberrations may be worse than single objective design.

FIG. 16E depicts another embodiment that could use a 12× 0.53 NA immersion at the sample; a 2× 0.5 NA air as O2 for 12× immersion; and a “blob” type 12× as O3 to collect full (available) NA. This embodiment can use, for example, an Olympus 2× with cap per LaVision; and an oblique illumination plane provided separately. For 1 um/pix we can get 3.2 mm FOV on kinetix. For 5 mm thick sample we would need >2 FOVs, which could work for 7 mm oblique FOV=28 degree tilt for illumination relative to surface.

While the present invention has been disclosed with reference to certain embodiments, numerous modifications, alterations, and changes to the described embodiments are possible without departing from the sphere and scope of the present invention, as defined in the appended claims. Accordingly, it is intended that the present invention not be limited to the described embodiments, but that it has the full scope defined by the language of the following claims, and equivalents thereof.

What is claimed is:

1. An imaging apparatus comprising:
an optical image splitter configured to route a first set of wavelengths of light towards a first array of first pixels of at least one camera and to route a second set of wavelengths of light towards a second array of second pixels of the at least one camera;
an optical beam combiner configured to route a plurality of beams of excitation light that emanate from a respective plurality of light sources onto a single common excitation path, wherein each of the plurality of light sources outputs a respective beam of excitation light that has a respective center wavelength;
a set of optical components configured to (a) route the plurality of beams of excitation light from the single common excitation path into a sample and (b) when a fluorophore within the sample emits light in response to incoming excitation light, route at least a portion of the emission light that exits the sample into the image splitter; and
at least one processor programmed to
activate each of the plurality of light sources during a respective timeslot, and
process image data captured using the first array of first pixels and/or image data captured using the second array of second pixels during each of the timeslots,
wherein, for at least one of the timeslots, the processing of the image data comprises using the image data captured using the first array of first pixels to detect a presence of a given fluorophore, and using the image data captured using the second array of second pixels to detect a presence of a different fluorophore.

2. The imaging apparatus of claim 1,
wherein the set of optical components comprises: <a first set of optical components having a proximal end, a distal end, and a first optical axis, wherein the first set of optical components includes a first objective disposed at the distal end of the first set of optical components;
a second set of optical components having a proximal end, a distal end, and a second optical axis, wherein the second set of optical components includes a second objective disposed at the distal end of the second set of optical components; and
a scanning element that is disposed proximally with respect to the proximal end of the first set of optical components and proximally with respect to the proximal end of the second set of optical components;
wherein the scanning element is positioned to route a sheet of excitation light so that the sheet of excitation light will pass through the first set of optical components in a proximal to distal direction and project into a sample that is positioned distally beyond the distal end of the first set of optical components, wherein the sheet of excitation light is projected into the sample at an oblique angle, and wherein the sheet of excitation light is projected into the sample at a position that varies depending on an orientation of the scanning element,
wherein the first set of optical components routes detection light from the sample in a distal to proximal direction back to the scanning element, and
wherein the scanning element is also positioned to route the detection light so that the detection light will pass through the second set of optical components in a proximal to distal direction and form an intermediate image plane at a position that is distally beyond the distal end of the second set of optical components;
a third set of optical components configured to expand each of the plurality of beams of excitation light into the sheet of excitation light; and
a third objective positioned to route light arriving from the intermediate image plane towards the image splitter, and
wherein the optical beam combiner comprises at least one pair of alignment mirrors configured to facilitate alignment of the plurality of beams of excitation light onto the single common excitation path.

3. The imaging apparatus of claim 1, further comprising:
the plurality of light sources, wherein each of the light sources comprises a laser; and
the at least one camera.

4. The imaging apparatus of claim 3, wherein the first array of first pixels and the second array of second pixels are located on a single camera sensor chip.

5. The imaging apparatus of claim 3, wherein the first array of first pixels and the second array of second pixels are located on two different camera sensor chips.

6. The imaging apparatus of claim 1, wherein the plurality of beams of excitation light comprises at least three beams of excitation light, each of which has a different center wavelength.

7. The imaging apparatus of claim 6, wherein the at least one processor is further programmed to
generate a matrix of spectral characterization for a plurality of pixels in the sample from the image data captured during each of the timeslots, and
unmix the matrix of spectral characterization to determine which, if any, fluorophores are present in each of the plurality of pixels.

8. The imaging apparatus of claim 7, wherein the at least one processor is further programmed to
measure an intensity at each first pixel in response to excitation with each of the beams of excitation light,
measure an intensity at each second pixel in response to excitation with each of the beams of excitation light,
generate an image M(r,λ) with r pixels acquired at wavelength combination λ of a sample containing N fluorophores using the equation
$$M ( r , λ ) = {\sum }_{n = 0}^{N} {c}_{n} ( r ) {f}_{n} ( λ )$$
where cₙ(r) is the spatial pattern of fluorophore concentrations at each position r, and fₙ(λ) is the spectral properties of each of the N fluorophores, respectively, for wavelength λ, and
using unmixing to determine which fluorophore or fluorophores is present at each pixel.

9. The imaging apparatus of claim 7, wherein the at least one processor is further programmed to implement unmixing using non-negative least squares fitting.

10. The imaging apparatus of claim 1, wherein the image splitter is configured to route wavelengths of light that are shorter than λ1 towards the first array of first pixels, and to route wavelengths of light that are longer than λ2 towards the second array of second pixels, wherein λ2 is greater than or equal to λ1,
wherein the imaging apparatus further comprises at least one first filter positioned in a path of the emission light at a position that precedes the first array of first pixels, wherein the at least one first filter blocks wavelengths of light that correspond to at least one of the beams of excitation light with a center wavelength shorter than λ1, and
wherein the imaging apparatus further comprises a second filter positioned in a path of the emission light at a position that precedes the second array of second pixels, wherein the second filter blocks wavelengths of light that correspond to a beam of excitation light with a center wavelength longer than λ2.

11. The imaging apparatus of claim 1, wherein the image splitter is configured to route wavelengths of light that are shorter than λ1 towards the first array of first pixels, to route wavelengths of light between λ1 and λ2 towards the second array of second pixels, and to route wavelengths of light that are longer than λ2 towards the first array of first pixels, wherein λ2 is at least 50 nm larger than λ1,
wherein the imaging apparatus further comprises at least one first filter positioned in a path of the emission light at a position that precedes the first array of first pixels, wherein the at least one first filter blocks wavelengths of light that correspond to at least one of the beams of excitation light with a center wavelength shorter than λ1.

12. The imaging apparatus of claim 11, further comprising a second filter positioned in a path of the emission light at a position that precedes the second array of second pixels, wherein the second filter blocks wavelengths of light that correspond to a beam of excitation light with a center wavelength between λ1 and λ2.

13. The imaging apparatus of claim 1, wherein the image splitter is configured to route wavelengths of light between λ1 and λ2 towards the first array of first pixels, to route wavelengths of light between λ2 and λ3 towards the second array of second pixels, to route wavelengths of light between λ3 and λ4 towards the first array of first pixels, to route wavelengths of light between λ4 and λ5 towards the second array of second pixels, wherein λ5>λ4>λ3>λ2>λ1,
wherein the imaging apparatus further comprises at least one first filter positioned in a path of the emission light at a position that precedes the first array of first pixels, wherein the at least one first filter blocks wavelengths of light that correspond to at least one of the beams of excitation light with a center wavelength between λ1 and λ2 or between λ3 and λ4.

14. The imaging apparatus of claim 13, further comprising a second filter positioned in a path of the emission light at a position that precedes the second array of second pixels, wherein the second filter blocks wavelengths of light that correspond to a beam of excitation light with a center wavelength between λ2 and λ3 or between λ4 and λ5.

15. An imaging method comprising:
directing a plurality of beams of excitation light that emanate from a respective plurality of light sources onto a single common excitation path, wherein each of the plurality of light sources outputs a respective beam of excitation light that has a respective center wavelength;
directing the plurality of beams of excitation light from the single common excitation path into a sample;
directing a first set of wavelengths of light emitted by fluorophores within the sample towards a first array of first pixels of at least one camera;
directing a second set of wavelengths of light emitted by fluorophores within the sample towards a second array of second pixels of the at least one camera;
activating each of the plurality of light sources during a respective timeslot; and
processing image data captured using the first array of first pixels and/or image data captured using the second array of second pixels during each of the timeslots,
wherein, for at least one of the timeslots, the processing of the image data comprises using the image data captured using the first array of first pixels to detect a presence of a given fluorophore, and using the image data captured using the second array of second pixels to detect a presence of a different fluorophore.

16. The imaging method of claim 15, wherein the first array of first pixels and the second array of second pixels are located on a single camera sensor chip.

17. The imaging method of claim 15, wherein the plurality of beams of excitation light comprises at least three beams of excitation light, each of which has a different center wavelength.

18. The imaging method of claim 17, further comprising:
generating a matrix of spectral characterization for a plurality of pixels in the sample from the image data captured during each of the timeslots, and unmixing the matrix of spectral characterization to determine which, if any, fluorophores are present in each of the plurality of pixels.

19. The imaging method of claim 18, further comprising:
measuring an intensity at each first pixel in response to excitation with each of the beams of excitation light,
measuring an intensity at each second pixel in response to excitation with each of the beams of excitation light,
generating an image M(r,λ) with r pixels acquired at wavelength combination λ of a sample containing N fluorophores using the equation
$$M ( r , λ ) = {\sum }_{n = 0}^{N} {c}_{n} ( r ) {f}_{n} ( λ )$$
where cₙ(r) is the spatial pattern of fluorophore concentrations at each position r, and fₙ(λ) is the spectral properties of each of the N fluorophores, respectively, for wavelength λ, and
using unmixing to determine which fluorophore or fluorophores is present at each pixel.

20. The imaging method of claim 18, further comprising implementing unmixing using non-negative least squares fitting.
